(19) United States
(12) Patent Application Publication
(10) Pub. No.: US 2025/0236461 A1
(43) Pub. Date: Jul. 24, 2025

(54) SYSTEMS AND METHODS FOR TRANSPORTING DISTRIBUTION ITEMS

(71) Applicant: United States Postal Service, Washington, DC (US)

(72) Inventor: Wayne R. Perry-Eaton, Leesburg, VA (US)

(21) Appl. No.: 19/030,996

(22) Filed: Jan. 17, 2025

Related U.S. Application Data
(60) Provisional application No. 63/622,470, filed on Jan. 18, 2024.

(51) Int. Cl. B65G 1/137; B65G 1/06; B65G 67/24

(52) U.S. Cl. CPC B65G 1/1371; B65G 1/065; B65G 67/24

(57) ABSTRACT

An automated system for transferring articles from a transport vehicle. The system includes a transport vehicle defining a matrix of cells, each cell sized to receive a tray, a source tray intake system for transporting a plurality of trays autonomously to another location. The source tray intake system includes a docking station having a matrix of arms configured to interact with a plurality of cells to transfer the trays from the cells of the transport vehicle onto the source tray intake system. The system is configured to transfer trays from the transport vehicle to the source tray intake system by an at least semi-automated process including positioning the transport vehicle in front of the docking station, inserting the arms within the cells of the transport vehicle, off-loading the trays along the arms, and transferring the trays onto the source tray intake system.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 63/622,470, the entire contents of which are hereby incorporated by reference.

### BACKGROUND

This disclosure relates to systems and methods for transfer of distribution items.

Items, such as letters, envelopes, postcards, etc., may be received, transported, transferred, processed, collected, sorted, or the like, in containers such as trays. Trays may be transported via human couriers or mechanical systems such as carts, conveyor belts, and elevators.

### SUMMARY

The systems and methods of this disclosure each have several innovative aspects, no single one is solely responsible for its desirable attributes. Without limiting the scope as expressed by the claims that follow, its more prominent features will now be discussed briefly.

In one aspect of the systems and methods disclosed herein, a tray transfer system is described. The tray transfer system comprises a transport vehicle defining a matrix of cells, each cell being sized to receive a tray containing one or more items; a conveyor system defining an intake flow path, the conveyor system comprising a docking station, one or more tray lifts, a cross conveyor, and a transition mechanism. The conveyor system is configured to transport a tray from the transport vehicle to a tray content transfer system. A lift mechanism transition the one or more rows of tray lifts between a loading position and a conveying position; and a docking station comprising a matrix of arms, the matrix of arms is the same as the matrix of cells such that the arms are inserted within corresponding cells for transferring the trays from the transport vehicle to the conveyor system.

In one aspect of the systems and methods disclosed herein, a method for implementing the system is described. Driving the transport vehicle to a proximate location located in front of the docking station; aligning the transport vehicle with the docking station by driving parallel to the docking station until the cells of the transport vehicle align with the arms of the docking station; driving the transport vehicle to an intake position located adjacent to the docking station such that the arms of the transport vehicle engage with the cells of the transport vehicle; systemically offloading the trays from the cells of the transport vehicle onto one or more tray lifts in a loading position; moving the one or more tray lifts to a conveying position; and activating the conveyor system to transport the trays to a tray content transfer system.

In one aspect of the systems and methods disclosed herein, a tray transfer system is described having a transport vehicle, a source tray intake, and a tray content system. The transport vehicle includes a plurality of cells sized to receive a tray. The source tray intake further includes a docking station, one or more tray lifts, and a cross conveyor. The docking station has a plurality of arms each having one or more conveyors. The one or more tray lifts each have one or more conveyors. The cross conveyor has one or more conveyors. One or more of the arms of the docking station are in communication with corresponding one or more cells of the transport vehicle. The tray lift is in communication with the docking station. The cross conveyor is in communication with the tray lift. The conveyors of the source tray intake define a source tray flow path. The tray content transfer system is in communication with the source tray flow path.

The above and other aspects have various embodiments. For example, in some embodiments, the tray lift is positioned adjacent to the docking station and the cross conveyor is positioned adjacent to at least a portion of the tray lift. In some embodiments, the cross conveyor is positioned along a conveying position. In some embodiments, the docking station is positioned along one or more loading positions. In some embodiments, the tray lift moves between a loading position and a conveying position. In some embodiments, the tray lift and cross conveyor are elevated. In some embodiments, the tray transfer system further includes a transition mechanism positioned between the cross conveyor and the tray contents transfer system. In some embodiments, the plurality of cells are organized in a matrix of rows and columns. In some embodiments, the arms extend from a plurality of platforms, wherein the docking station has a same number of platforms as the transport vehicle has rows and wherein each platform has the same number of arms as the transport vehicle has columns. In some embodiments, the tray transfer system further includes a plurality of vertical supports. In some embodiments, the vertical supports vertically actuate the tray lift between a conveying position and a loading position. In some embodiments, the tray transfer system further includes a plurality of tray lifts organized in rows. In some embodiments, the conveyors are driven rollers, omni- or multi-directional rollers, traditional conveyor belts, or a gravity roller conveyor system. In some embodiments, the tray lift is vertically actuated between a conveying position and a plurality of loading positions, wherein the plurality of loading positions correspond to the rows of platforms. In some embodiments, the transport vehicle is autonomously driven.

In another aspect, a method for operating a tray transfer system is described that includes approaching a proximate location of a docking station with a transport vehicle, engaging the docking station with the transport vehicle, offloading one or more trays systematically from the transport vehicle to a tray lift, moving the tray lift from a loading position to a conveying position, offloading the trays systematically from the tray lift to a cross conveyor; conveying the trays along the cross conveyor, offloading the trays systematically from the cross conveyor to a transition mechanism; conveying the trays along the transition mechanism to an offloading position, and offloading trays systematically from the transition mechanism to a tray content transfer system.

The above and other aspects have various embodiments. For example, in some embodiments, the offloading trays systematically from the transport vehicle further comprises shuffling the trays into a correct conveying order. In some embodiments, shuffling the trays into a correct conveying order further includes assigning a processing position to the trays, identifying an active tray position, offloading an active tray into the active tray position; comparing a specific processing position of the active tray to an active spot of the conveying order, moving the active tray to a holding position, offloading a correct tray from a holding cell of the transport vehicle onto the tray lift; moving the correct tray into the active tray position, moving the active tray into the holding cell, and iterating the active tray position.

In another aspect, a source tray intake system is described. The source tray intake system includes a docking station, one or more tray lifts, a cross conveyor, and one or more lift mechanisms. The docking station further includes one or more platforms and one or more arms extending from each of the one or more platforms. The one or more platforms define a corresponding loading position. The one or more tray lifts are positioned adjacent to the docking station. The cross conveyor is positioned adjacent to the one or more tray lifts when in a conveying position. The one or more lift mechanisms are coupled to the one or more tray lifts and configured to actuate the one or more tray lifts between the conveying position and the one or more loading positions. The docking station, the one or more tray lifts, and the cross conveyor include conveyors. The conveyors of the docking station, the one or more tray lifts, and the cross conveyor define a source tray intake path.

In another aspect, a tray transfer system comprises a source tray intake comprising: a plurality of arms each of the plurality of arms having one or more conveyors wherein each of the one or more conveyors is configured to access a cell of a transport vehicle; one or more tray lifts wherein each one or more tray lifts comprises one or more conveyors, the one or more tray lifts proximate the plurality of arms and configured to receive a tray; and a cross conveyor comprising one or more conveyors and configured to receive the tray from the one or more tray lifts; and a transition mechanism proximate the cross conveyor, the transition mechanism comprising: one or more baskets configured to receive the tray; and a lifting mechanism coupled to the one or more baskets wherein the lifting mechanism is configured to deliver the tray from the one or more baskets to a tray content transfer system and thereafter transport the trays to an empty source tray collection.

In some embodiments, each arm of the plurality of arms comprises an actuator configured to independently actuate the one or more conveyors of the arm.

In some embodiments, the one or more tray lifts is coupled to a lifting mechanism configured to elevate the one or more tray lifts from a first position proximate the plurality of arms to a second position proximate the cross conveyor.

In some embodiments, the cross conveyor is elevated above a processing apparatus such that the cross conveyor is proximate to the one or more tray lifts when the one or more tray lifts is in the second position.

In some embodiments, the one or more conveyors of each arm of the plurality of arms comprises a celluveyor.

In some embodiments, the plurality of arms further comprises one or more scanners configured to read a computer readable code located on the tray; and selectively activate the one or more conveyors of the plurality of arms.

In some embodiments, the one or more baskets comprises one or more conveyors configured to move the tray from the transition mechanism to the tray content transfer system.

In some embodiments, the one or more conveyors of the one or more baskets comprises a celluveyor configured to move the tray in a multiple directions.

In some embodiments, the plurality of arms extend from a plurality of platforms, wherein the docking station has a same number of platforms as the transport vehicle has rows and wherein each platform has the same number of arms as the transport vehicle has columns.

In some embodiments, the transition mechanism is coupled to a lifting mechanism configured to lower the one or more baskets from a first position proximate the cross conveyor to a second position proximate the tray content transfer system.

In some embodiments, the transport vehicle is an autonomous vehicle configured to automatically transport the tray from a storage location to the source tray intake upon receipt of a signal from the tray transfer system.

In another aspect describe herein, a method for operating a tray transfer system comprises positioning one of a plurality of arms in a plurality of cells of a transport vehicle; moving a plurality of trays in the plurality of cells out of the transport vehicle and onto one or more tray lifts disposed proximate the plurality of arms, each of the tray lifts comprising one or more lift conveyors; lifting, via the one or more tray lifts, the plurality of trays from a first elevation to a second elevation; moving the trays via the one or more lift conveyors to a cross conveyor wherein the plurality of trays are moved individually onto the cross conveyor, the cross conveyor being disposed at the second elevation; moving each of the plurality of trays via the cross conveyor into a basket a plurality of baskets of a transition mechanism; and lowering, via the plurality of baskets, each of the plurality of trays to an output position lower than the second position, the output position proximate an intake for a tray content transfer system; and moving each of the plurality of trays to the tray content transfer system.

In some embodiments, each arm of the plurality of arms comprises an arm conveyor and each arm conveyor is independently operable from the arm conveyors on others of the plurality of arms.

In some embodiments, the cross conveyor is elevated above an item processing apparatus and wherein the tray content transfer system feeds items into the item processing apparatus.

In some embodiments, the method further comprises scanning, via a scanner proximate the plurality of arms, one or more computer readable codes located on the plurality of trays; and
identifying, in one or more processors, based on the computer readable codes, a characteristic of items in a first tray of the plurality of trays;
selectively activate a conveyors of a first arm of the plurality of arms, the first arm being positioned within a first cell of the transfer vehicle, the first cell containing the first tray; and
moving the first tray of the plurality of trays into a first position on a first one of the one or more lift conveyors based on the identified characteristic.

In some embodiments, the method further comprises identifying a second characteristic of a second tray of the plurality of trays; and selectively activating a conveyor on the second arm, the second arm being inserted into a second cell of the plurality of cells of the transfer vehicle, the second cell containing the second tray.

In some embodiments, the method further comprises moving the one or more tray lifts such that a second one of the one or more tray lifts is proximate the second arm; and moving the second tray onto the second one of the one or more tray lifts.

In some embodiments, the characteristic of the items in one tray comprise an item type.

In some embodiments, the characteristic comprises an intended delivery destination.

In some embodiments, the method further comprises receiving, in an empty basket of the one or more baskets, an empty tray from the tray content transfer system; and moving the empty tray out of the transition mechanism to a storage location.

### BRIEF DESCRIPTION OF THE DRAWINGS

The foregoing and other figures of the disclosure will become more fully apparent from the following description and appended claims, taken in conjunction with the accompanying drawings.

FIG. 1 is a schematic illustration of an exemplary tray transfer system including a source tray intake system.

FIG. 2 is a perspective view of an exemplary tray transfer system, including a source tray intake system.

FIG. 3 is a top view of an exemplary tray transfer system.

FIG. 4 is a perspective view of an exemplary source tray intake system.

FIG. 5 is a top view of an exemplary source tray intake system.

FIG. 6 is a perspective view of a movable cart for use with a source tray intake system.

FIG. 7 is a side elevation view of a movable cart for use with a source tray intake system.

FIG. 8A is a perspective view of an exemplary tray transfer system.

FIG. 8B is a perspective view of an exemplary tray transfer system with a movable cart aligned with a source tray intake system.

FIG. 8C is a perspective view of an exemplary tray transfer system with a first row of trays in a loading position on a first tray lift after being unloaded from a movable cart by a source tray intake system.

FIG. 8D is a perspective view of an exemplary tray transfer system with an elevated first row of trays in a conveying position along a first tray lift and a second row of trays in a loading position on a second tray lift.

FIG. 8E is a perspective view of an exemplary tray transfer system with a first row of trays partially transferred between a first tray lift and a cross-conveyor.

FIG. 8F is a perspective view of an exemplary tray transfer system with a first row of trays partially transferred along a cross-conveyor and an elevated second row of trays in a conveying position along a second tray lift.

FIG. 8G is a perspective view of an exemplary tray transfer system with a first row of trays partially transferred between a cross-conveyor and a transition mechanism and a second row of trays partially transferred between a second tray lift and the cross-conveyor.

FIG. 8H is a perspective view of an exemplary tray transfer system with a first row of trays partially transferred by a transition mechanism and a second row of trays partially transferred along a cross-conveyor.

FIG. 8I is a perspective view of an exemplary tray transfer system with partially transferred rows of trays and first and second tray lifts lowered to receive additional rows of trays.

FIG. 8J is a perspective view of an exemplary tray transfer system with partially transferred rows of trays and an elevated third row of trays in a conveying position along a third tray lift and a fourth row of trays in a loading position on a fourth tray lift.

FIG. 9 is a flow chart of an exemplary tray transfer system.

FIG. 10 is a flow chart of an exemplary tray shuffling process.

### DETAILED DESCRIPTION

In the following detailed description, reference is made to the accompanying drawings. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented. It will be readily understood that the aspects of the present disclosure and illustrated in the figures, can be arranged, substituted, combined, and designed in a wide variety of different configurations by a person of ordinary skill in the art, all of which are made part of this disclosure.

Reference in the specification to “one embodiment,” “an embodiment”, or “in some embodiments” means that a particular feature, structure, or characteristic described in connection with the embodiment is included in at least one embodiment of the invention. Moreover, the appearance of these or similar phrases throughout the specification does not necessarily mean that these phrases all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

In processing items in a distribution network distribution items, such as parcels, packages, mailpieces, flats, boxes, bags, bins, luggage, inventory, products, and the like can be transported in containers, such as trays. Items such as letters, postcards, envelopes, or other stackable items may be received, transported, and processed in trays. In some item processing implementations, two or more different types of trays may be used. For example, items may be received in a first type of tray which may be optimized for transport of items outside of a processing facility (e.g., may be flexible, lightweight, inexpensive to manufacture, sized and shaped to fit in an item collection system, or the like). When a tray of items is received at a processing facility, a second type of tray may be better suited for transport of the items within the facility for processing. For example, a second type of tray may be configured to be compatible with automated processing machinery at the processing facility (e.g., may have structural features designed to interact with particular processing machines and/or may be more rigid or dimensionally stable to facilitate automated processing of items). Thus, items received in the first type of tray may need to be transferred to the second type of tray before at least a portion of the desired processing occurs.

Transferring trays such as soft-sided intake trays or rigid automation-friendly processing trays from a movable cart to a tray transferring system has historically been performed manually. Manual transfer of trays can be time-consuming and imprecise, and prone to errors or mistakes. Trays may be dropped while being manually transferred, thereby spilling the items contained by the tray, or may be placed on the tray transfer system in a random order, thereby compromising the order of contents organized in the trays. For example, items such as letters may be placed in a uniformly faced arrangement in the trays, and operator error during transfer of the trays may cause some of the letters to face the opposite direction after transfer, resulting in processing errors or delays. Similarly, the trays may be organized in a particular order, and operator error during the transfer of the trays may cause the trays to be transferred in an incorrect order, resulting in processing errors or delays.

The tray transfer systems disclosed herein are configured to provide an automated process for transferring trays from a movable cart to a tray transfer system. In some embodiments, the tray transfer systems may transfer trays more reliably, efficiently, cost-effectively, and/or quickly than existing manual methods of tray transfer. Although the present disclosure describes tray transfer systems in the context of trays and flat items such as letter mail, it will be understood that other containers and items can be used without departing from the scope of the present disclosure.

Generally described, embodiments of the systems described herein use a combination of rotational and linear motion to reliably and efficiently transfer trays between a source cart and a tray transfer system better suited for use with further processing of the items, such as a rigid tray.

The present invention provides a tray transfer system that streamlines the handling and sorting of trays containing various contents. The system incorporates an elevated conveyor mechanism positioned above a sorting system to optimize space and efficiency. When a loaded cart reaches the tray transfer system, the multiple loaded trays are automatically transported via rollers or other conveyor mechanism to the sorting area, eliminating the need for manual tray placement. Once the loaded trays reach the sorting system, the trays are unloaded and stacked using another lift mechanism for retrieval and reuse. The elevated, compact, and automated design provides for a consistent flow to streamline the sorting process.

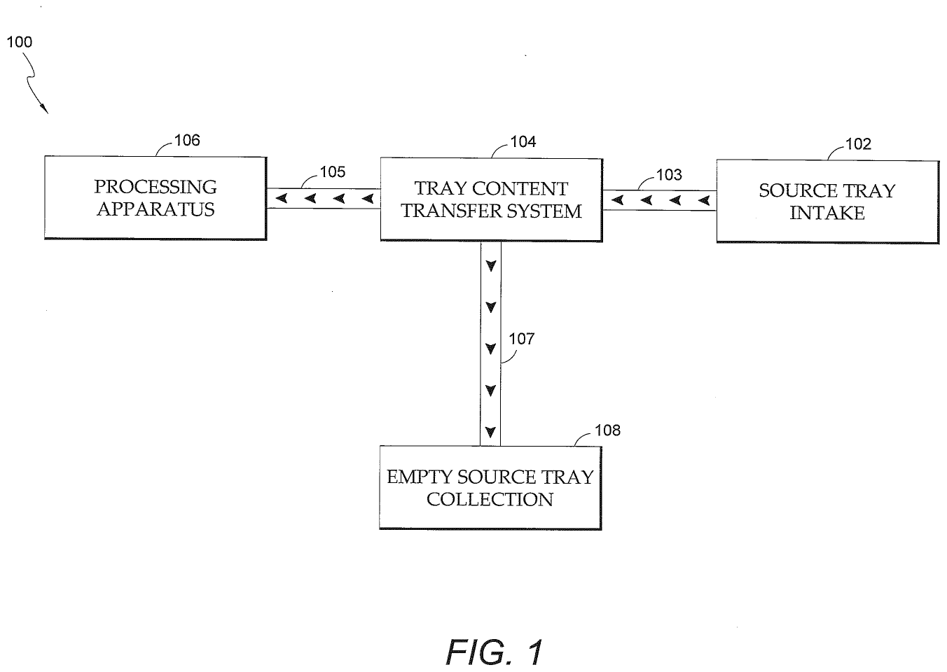

FIG. 1 schematically illustrates an example item processing system 100 including a source tray intake 102. The item processing system 100 further includes a tray content transfer system 104, a processing apparatus 106, and an empty source tray collection 108. Trays can be transferred between the components of the item processing system 100 by an intake flow path 103, an output flow path 105, and an empty source tray flow path 107. Each of the flow paths 103, 105, and 107 can be a conveyor, such as a moving conveyor belt surface, a series of rollers, or any other conveying system configured to move one or more trays laterally and/or vertically. The item processing system 100 includes processing trays and/or the contents of the trays.

The tray content transfer system 104 receives an item-containing source tray from the source tray intake 102 via the intake flow path 103. At the tray content transfer system 104, the items in the source tray are transferred from the source tray to an empty process tray. After the transfer, the process tray contains the items previously received in the source tray. The item-containing process tray is then sent to the processing apparatus 106 via the output flow path 105. The empty source tray is sent to the empty source tray collection 108 via the empty source tray flow path 107. After the source tray and process tray leave the tray content transfer system 104, the example method can be repeated with a second item-containing source tray and a second empty process tray.

In an exemplary method of operation, the source tray intake 102 includes one or more devices or systems for providing item-containing source trays. For example, the source tray intake 102 includes a docking station where item-containing source trays are received from transport vehicles for processing. In some embodiments, the source tray intake 102 can be an output of another process to be performed before tray content transfer. For example, in some letter mail processing embodiments, the source tray intake 102 may include a facer-canceler system configured to apply a cancellation to letters and place the letters in a uniformly faced horizontal stack within source trays.

The processing apparatus 106 can include one or more devices or systems for processing the items after tray content transfer. For example, the processing apparatus 106 can include any number of machines configured to scan, weigh, measure, sort, order, combine, separate, analyze, or otherwise process the items. In some letter mail processing embodiments, the processing apparatus 106 can include one or more machines for automatically reading information provided on the letters (e.g., postage information, destination address, return address, etc.) and/or sorting the letters for further transportation.

The empty source tray collection 108 and empty process tray supply can include one or more lines, piles, stacks, carts, dispensers, receivers, or other structures capable of holding a plurality of trays. For example, the empty source tray collection 108 may include a tray receiving system located at an end of the empty source tray flow path 107 for receiving and stacking or otherwise organizing empty source trays to be reused for transporting additional items. The empty process tray supply can include one or more stacks, dispensers, or the like, for placing empty process trays into the empty process tray flow path for delivery to the tray content transfer system 104.

The exemplary method described above with reference to FIG. 1 can be repeated any number of times or indefinitely, for example, based on a desired number or rate of item-containing source trays received for processing. In some embodiments, the tray content transfer system 104 can be configured to transfer the contents of two or more source trays to a single process tray, to transfer the contents of a single source tray to two or more process trays, or to transfer the contents of two or more source trays to two or more process trays simultaneously. In addition, various components of the item processing system 100 can be automated and/or performed manually. For example, any of the flow paths 103, 105, 107 can be performed manually at least in part, such as by an operator manually placing one or more loaded or empty trays onto a conveyor or directly into the tray content transfer system 104.

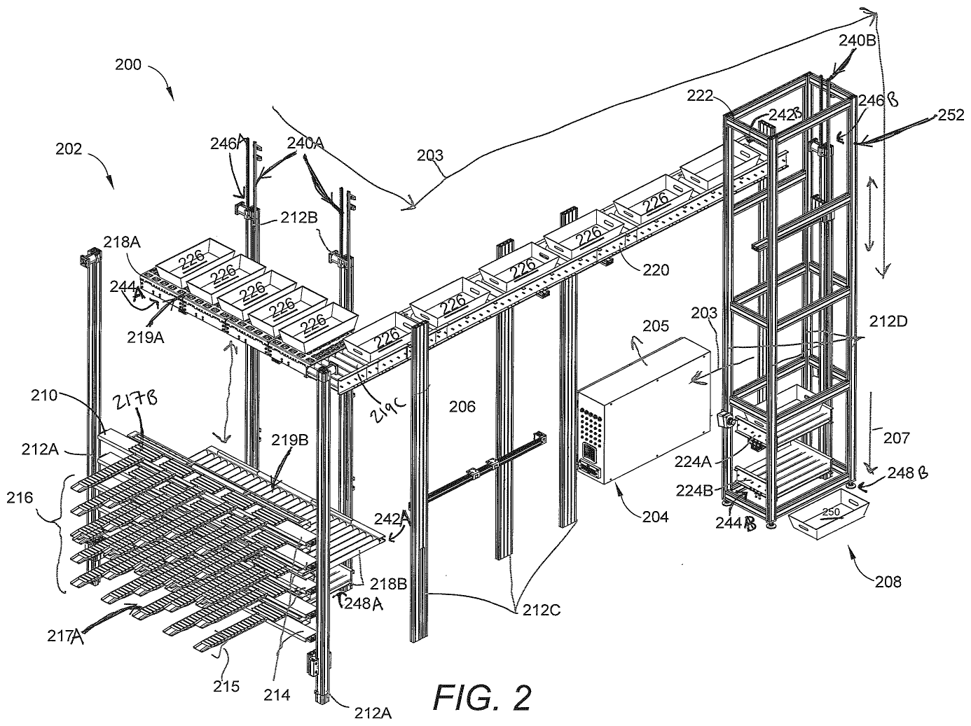

FIG. 2 illustrates a tray processing system 200 comprising a source tray intake system 202, an intake flow path 203, a tray content transfer system 204, an output flow path 205, a processing apparatus 206, an empty source tray flow path 207, and an empty source tray collection 208. The source tray intake system 202 further comprises a plurality of vertical supports 212A, 212B, 212C, 212D, a docking station 210; one or more tray lifts 218A, 218B; a cross conveyor 220; and a transition mechanism 222. The docking station further includes one or more platforms 214, and a plurality of arms 216. The tray processing system 200 may be configured to transport one or more trays 226 along any of the flow paths 203, 205, 207.

The intake system 202 may be any device for intaking and conveying a source tray. The source tray intake system 202 further comprises a plurality of vertical supports 212A, 212B, 212C, 212D, a docking station 210; one or more tray lifts 218A, 218B; a cross conveyor 220; and a transition mechanism 222. The docking station further includes one or more platforms 214, and a plurality of arms 216. In some embodiments, the docking station 210 can have only a single platform 214 and a row of arms 216.

The intake flow path 203 is defined by the collective conveying directions of the docking station 210, the tray lifts 218A, 218B, the cross conveyor 220, and the transition mechanism 222. The intake flow path 203 traverses a plurality of elevations. As shown in FIG. 2, the intake flow path 203 is elevated extending to an unloading position. In some embodiments, the intake flow path 203 is generally located in an elevated position above the processing apparatus 206 as shown in FIG. 2. For example, the elevated position may be between 100 and 120 inches above the ground. Alternatively, the intake flow path 203 may be located along a semi-elevated position corresponding to the height of the processing apparatus 206. For example, the semi-elevated position may be between 25 and 40 inches above the ground. Furthermore, the one or more loading positions may share the same height as the processing apparatus 206. By positioning the intake flow path 203 above the processing apparatus 206, equipment footprints may be reduced, facility space can be economized, and processing efficiency can be improved.

The tray content transfer system 204 may be any tray content transfer system known in the art. For example, the tray content transfer system 204 may comprise a frame configured to rotate about a rotation axis between an upright orientation and a rotated orientation; a first retainer coupled to the frame and configured to secure a first tray within the tray content transfer system 204, the first tray containing one or more items; a second retainer coupled to the frame and configured to secure a second tray within the tray content transfer system at a location spaced from the first tray along a longitudinal axis parallel to the rotation axis; a paddle assembly movably coupled to the frame, the paddle assembly comprising a plurality of paddles, wherein the distance between the paddles is adjustable to selectively engage and release items at least partially disposed between the paddles, and wherein the paddle assembly is movable relative to the frame along a first linear axis parallel to the longitudinal axis and a second linear axis perpendicular to the first linear axis; and a plurality of motors configured to adjust the distance between the paddles, to move the paddle assembly along the first linear axis and the second linear axis, and to rotate the frame about the rotation axis, in a predetermined sequence to transfer the one or more items from the first tray to the second tray. In some embodiments, the first tray is a soft-sided source tray and the second tray is a hard-sided process tray.

The output flow path 205 is defined by a conveying direction of the tray content transfer system 204 for conveying the contents of a tray 226 from the tray content transfer system 204 to the processing apparatus 206.

The processing apparatus 206 can include any one or more devices or systems for processing the items after tray content transfer. For example, the processing apparatus 206 can include any number of machines configured to scan, weigh, measure, sort, order, combine, separate, analyze, or otherwise process the items. In some letter mail processing embodiments, the processing apparatus 206 can include one or more machines for automatically reading information provided on the letters (e.g., postage information, destination address, return address, etc.) and/or sorting the letters for further transportation.

The empty source tray flow path 207 is defined by the conveying direction of the transition mechanism 222 for conveying a tray 226 from the tray content transfer system 204 to the empty source tray collection 208.

The empty source tray collection 208 can be a designated location to output empty source trays 250. The empty source trays 250 may be stacked in the empty source tray collection 208.

The docking station 210 is an intake device for receiving an object, such as a tray 226 described in greater detail below. The docking station 210 may be positioned at the beginning of the intake system 202. The docking station 210 further includes one or more platforms 214, and a plurality of arms 216. The docking station 210 can include one or more scanners, such as optical scanners, RFID readers, and the like, configured to detect the presence of a cart, read a computer readable code on the cart, on a tray 226, and the like. The scanners can provide signals to various components of the tray processing system 200 to selectively activate components in response to reading the identifiers on carts and trays 226. For example, if trays 226 on a cart need to be unloaded in a particular order based on item service class, an item type, machine type, etc., the tray processing system 200 can control the components described herein to first unload the cells of the cart having trays which are to be processed first, which have an expected or determined type of items, etc. The computer readable codes on the trays can include or be associated with properties or characteristics of distribution items located in the trays. In some embodiments, the properties or characteristics can include intended delivery points or destinations for the items, item type, item class of service, etc. When the trays are scanned and the labels or codes on the trays are read, the tray processing system 200 can determine in which order to move the trays based on item type, item destinations, etc.

The vertical supports 212A-212D extend vertically from a ground surface. The ground surface is a horizontal reference point for the tray processing system 200. As shown in FIG. 2, the vertical supports 212A support the docking station 210, the vertical supports 212B support the one or more tray lifts 218A, 218B, the vertical supports 212C support the cross conveyor 220, and the vertical supports 212D support the transition mechanism 222.

In some embodiments, at least some of the vertical supports 212A-212D include a lifting mechanism 240A, 240B. The lifting mechanism 240A, 240B is configured to move an object between two or more positions. The lifting mechanism 240A, 240B may include a track and one or more actuators. The lifting mechanism 240A, 240B moves the one or more objects between two or more positions along the track. The lifting mechanism 240A, 240B extends at least between a first position 242B, 244A and a second position 242A, 244B. In some embodiments, the first position 242 is proximal to a first end 246A, 246B of the vertical supports 212A-212D and the second position 244 is proximal to a second end 248A, 248B of the vertical supports 212A-212D. In some embodiments, the first position 242A, 244B may correspond to one or more loading positions. In some embodiments, the second position 242A, 244B may correspond to a conveying position. The one or more actuators translate between the one or more first positions and the one or more second positions.

In some embodiments, the lifting mechanism 240A, 240B may be a pulley system, a magnetic track, a mechanical or electrical motor, hydraulic system, or the like. The pulley system may include one or more motors, one or more rotational pulleys, and one or more cables. The cables may extend between the pulleys.

The one or more platforms 214 each further include one or more conveyors, and one or more mounting segments. The one or more platforms 214 may be vertically aligned with each of the one or more platforms 214 positioned along a single vertical plane.

The one or more conveyors 217B of each of the one or more platforms 214 may be any device known in the art for moving an object from one location to another. For example and without limitation, the one or more conveyors may be driven rollers, omni- or multi-directional rollers such as a celluveyor, a traditional conveyor belt, or a gravity roller conveyor system having a plurality of rollers with ball bearings and one end of the conveyor elevated above a second end of the conveyor. In some embodiments, each of the conveyors 217B of the one or more platforms 214 includes its own motor. In such embodiments, each of the one or more conveyors 217B of each of the one or more platforms 214 may be individually actuated. In some embodiments, the one or more conveyors 217B of each of the one or more platforms may be actuated by fewer motors than rollers by implementing a coupler such as a gear train, chain, or pulley system. The one or more conveyors 217B of each of the one or more platforms 214 may be positioned along at least a top surface of the body. In some embodiments, the one or more conveyors 217B of each of the one or more platforms 214 may be equidistantly spaced along the length of the body of each of the one or more platforms 214.

In some embodiments, the docking station 210 has the same number of platforms 214 as a transfer vehicle and/or cart has rows, as described in greater detail below. Each of the one or more platforms 214 may define a loading position.

The plurality of arms 216 each further include one or more conveyors 217A. The plurality of arms 216 are horizontally oriented along one or more horizontal planes. The plurality of arms 216 may be organized into sets 215 on each platform 214. Each arm 216 of the platform 214 set 215 may be horizontally aligned with the other arms 216 of the set 215. In some embodiments, the sets 215 may be vertically aligned with the other sets 215.

The conveyors 217A of the plurality of arms 216 may be any device known in the art for moving an object from one location to another. For example and without limitation, the conveyors 217A may be driven rollers, omni- or multi-directional rollers such as a celluveyor, a traditional conveyor belt, or a gravity roller conveyor system having a plurality of rollers with ball bearings and one end of the conveyor elevated above a second end of the conveyor. In some embodiments, each of the conveyors 217A includes its own motor. In such embodiments, each of the conveyors 217A of the plurality of arms 216 may be individually actuated. In some embodiments, the conveyors 217A of each arm 216 may be actuated by fewer motors than rollers by implementing a coupler such as a gear train, chain, or pulley system. The conveyors 217A of each arm 216 may be positioned along at least a top surface of the body. In some embodiments, the one or more conveyors 217A of the plurality of arms 216 may be extend across the length of the arm 216. In some embodiments, the one or more conveyors 217A, 217B of each arm 216 and platform 214 area single, continuous conveyors that extend across the arm 216 and platform 214. In some embodiments, the one or more conveyors 217A, 217B of the arm 216 and platform 214 are separate, independent conveyors that operate with one another to transfer trays 226.

In some embodiments, the docking station 210 has the same number of arms 216 in each set 215 as the number of columns of a transfer vehicle and/or cart, as described in greater detail below.

The one or more tray lifts 218A, 218B further include a body and one or more conveyors 219A, 219B.

The body of the tray lifts 218A, 218B extends between a first end and a second end. The body of the tray lifts 218A, 218B is horizontally oriented. In some embodiments, the body of the tray lifts 218B may include parallel rails separated by a distance. In some embodiments, the body of the tray lifts 218A may be a housing defining a plurality of openings.

The body of the tray lifts 218A, 218B may include a plurality of tray positions. The tray positions may be an array or range of positions along the tray lifts 218A, 218B on which a tray may be positioned. Additionally, the body of the tray lifts 218A, 218B may further include one or more holding positions.

The one or more conveyors 219A, 219B of the tray lifts 218A, 218B may be any device known in the art for moving an object from one location to another. For example and without limitation, the conveyor 219A, 219B may be driven rollers as shown in the tray lifts 218B, omni- or multi-directional rollers such as a celluveyor as shown in the tray lift 218A, a traditional conveyor belt, or a gravity roller conveyor system having a plurality of rollers with ball bearings and one end of the conveyor elevated above a second end of the conveyor. In some embodiments, each of the conveyors 219A, 219B includes its own motor. In such embodiments, the conveyor 219A, 219B of the tray lifts 218A, 218B may be individually actuated. In some embodiments, the conveyors 219A, 219B of the tray lifts 218A, 218B may be actuated by fewer motors than rollers by implementing a coupler such as a gear train, chain, or pulley system. The one or more conveyors 219A, 219B of the tray lifts 218A, 218B may be positioned along at least a top surface of the body. The orientation of the conveyors 219A, 219B of the tray lifts 218A, 218B may be orthogonal to the orientation of the conveyors 217 of the one or more platforms 214 and/or of the plurality of arms 216. In some embodiments, the one or more conveyors 219A, 219B extend between the two parallel rails separated a conveyor, such as rollers, a belt, a celluveyor, etc . . . Additionally and/or alternatively, the conveyors 219A, 219B may protrude through the plurality of openings defined by the housing.

The cross conveyor 220 further includes one or more conveyors 219C. The body of the cross conveyor 220 extends between a first end and a second end. The body of the cross conveyor 220 is horizontally oriented. In some embodiments, the body of the cross conveyor 220 may include parallel rails separated by a distance. In some embodiments, the body of the cross conveyor 220 may be a housing defining a plurality of openings. In some embodiments, the body of the cross conveyor 220 may include side rails and/or protective barriers extending vertically from the lateral sides of the cross conveyor 220.

The one or more conveyors 219C of the cross conveyor 220 may be any device known in the art for moving an object from one location to another. For example and without limitation, the conveyor 219C may be driven rollers, omni- or multi-directional rollers such as a celluveyor, a traditional conveyor belt, or a gravity roller conveyor system having a plurality of rollers with ball bearings and one end of the conveyor elevated above a second end of the conveyor. In some embodiments, each of the conveyors 219C includes its own motor. In such embodiments, the conveyor 219C of the cross conveyor 220 may be individually actuated. In some embodiments, the conveyors 219C of the cross conveyor 220 may be actuated by fewer motors than rollers by implementing a coupler such as a gear train, chain, or pulley system. The one or more conveyors 219C of the cross conveyor 220 may be positioned along at least a top surface of the body. The orientation of the conveyors 219C of the cross conveyors 220 may be orthogonal to the orientation of the conveyors of the tray lifts 218A, 218B. In some embodiments, the orientation of the conveyors 219C of the cross conveyors 220 may be parallel to the orientation of the conveyors of the platforms 214 and/or of the plurality of arms 216. In some embodiments, the one or more conveyors 219C extend between the two parallel rails separated by a distance. The distance may be defined by the length of a conveyor.

The transition mechanism 222 may be any device configured to transition an object from the source tray intake system 202 to the tray content transfer system 204 and/or the empty source tray collection 208. In some embodiments, the transition mechanism 222 further includes a frame 252 and one or more movable baskets 224A, 224B. The transition mechanism 222 is vertically oriented. The transition mechanism 222 may extend at least between a conveying position and the tray content transfer system 204 and/or between the tray content transfer system 204 and the empty source tray collection 208. The frame 252 may be defined by the one or more vertical supports 212D.

Additionally and/or alternatively, the transition mechanism 222 may include a plurality of conveyors arranged along a slope extending from a first height to a second height. In some embodiments, the transition mechanism 222 may be a vertically oriented helical conveyor mechanism for conveying an object from a first height to one or more second heights. The first height may be a conveying position. The one or more second heights may correspond to the tray content transfer system 204 and/or the empty source tray collection 208.

The one or more baskets 224A, 224B each include a flat, shallow body. The one or more baskets 224A, 224B may be rectangularly shaped. The one or more baskets 224A, 224B may be a receptacle. The one or more baskets 224A, 224B are sized to receive the one or more trays 226. The one or more baskets 224A, 224B may include two or more sidewalls. In some embodiments, the one or more baskets 224A, 224B include a sidewall on two opposing sides. The remaining sides may not include a sidewall.

The one or more trays 226 may be any flat, shallow container or receptacle. The one or more trays 226 may further include raised edges. The one or more trays 226 may be source trays, processing trays, or other box-shaped object. Source trays may be formed of a light-weight, soft-sided material. The soft-sided source trays may be damaged through processing. Accordingly, the soft-sided source trays may be unsuitable for processing. Processing trays may be formed of a durable material. In some embodiments, processing trays are formed of plastic. The durable processing trays may withstand processing. In some embodiments, the one or more trays 226 may be source trays.

The one or more trays 226 may contain one or more items. The one or more items may include post such as letters, postcards, envelopes, parcels, or other stackable items.

The vertical supports 212A-212D of the source tray intake system 202 provide a stable support for the docking station 210, the tray lifts 218, the cross conveyor 220, and the transition mechanism 222. In some embodiments, the one or more platforms 214, the tray lifts 218A, 218B, and/or the baskets 224 are configured to move vertically along the vertical supports 220A, 220B, 220D.

The one or more platforms 214 couple to the vertical supports 212A. The vertical supports 212A provide a stable support for the one or more platforms 214. In some embodiments, the one or more platforms 214 mount to the lifting mechanism 240A of the vertical supports 212A via the mounting segments of the one or more platforms 214. Accordingly, the lifting mechanism 240A of the vertical supports 212A are configured to move the one or more platforms 214 vertically along the vertical supports 212A, 212B. For example, the vertical supports 212A translate the one or more platforms 214 vertically between one or more loading positions and a conveying position.

The plurality of arms 216 couple to the one or more platforms 214. The one or more platforms 214 provide a stable platform for the plurality of arms 216 to intake objects. In some embodiments, the plurality of arms 216 are connected to the one or more platforms 214.

As shown in FIG. 2, the one or more platforms 214 and plurality of arms 216 may be arranged in an array and/or matrix of arms 216 extending from the one or more platforms 214. The docking station 210 can have any number of arms 216 extending from any number of platforms 214. The plurality of arms 216 are organized in an array or N by M matrix having “N” number of rows and “M” number of columns. The number of rows corresponds to the number of platforms 214. The number of columns corresponds to the number of arms 216 extending from each platform 214. For example, five arms 216 may extend from each of five platforms 214 forming a 5×5 matrix. Accordingly, the docking station 210 can have twenty-five total arms 212 organized in a 5×5 matrix, as shown in FIG. 2. In some embodiments, the docking station 210 may have a single row and/or a single column. For example, docking station 210 may include a plurality of arms 216 extending from a single platform 214. Alternatively, the docking station 210 may include a single arm 216 extending from each of a plurality of platforms 214. In some embodiments, the plurality of arms 216 are equally spaced along each of the one or more platforms 214.

The docking station 210 may have a plurality of arms 216 organized in a pattern. As shown in FIG. 2, the pattern is uniform for all platforms 214. In some embodiments, the pattern may be a lattice pattern. A lattice pattern may offset the arms 216 of each platform 214 relative to the arms 216 of the adjacent platforms 214, respectively. For example, a docking station 210 may include three or more platforms 214, each platform 214 comprising the same number of arms 216 The arms 216 on the even-numbered platforms 214 may be horizontally aligned and the arms 216 on the odd-numbered platforms 214 may be horizontally aligned, wherein the arms 216 of the even-numbered platforms 214 are horizontally offset from the arms 216 of the odd-numbered platforms 214. In some embodiments, the docking station 210 can have an unequal number of arms 216 extending from the one or more platforms 214. In such embodiments, the lattice pattern may alternate between platforms 214 with two different numbers of arms 216. In some embodiments, the offset may place the arms 216 of a first platform 214 centrally between arms 216 of an adjacent platform 214. In some embodiments, the docking station 210 can have an unequal number of arms 216 extending from one or more platforms 214. For example, the pattern may be a triangular pattern with two or more platforms 214 with incrementally increasing and/or decreasing numbers of arms 216. Accordingly, the docking station 210 can have any number of arms 216 extending from any number of platforms 214 as desired for a specific implementation. Additionally, the plurality of arms need not be spaced equally along the one or more platforms 214.

The tray lifts 218A, 218B are coupled to the vertical supports 212B, as shown in FIG. 2. In some embodiments, the tray lifts 218A, 218B may be coupled to a lift mechanism of the vertical supports 212B. In such embodiments, the tray lifts 218A, 218B may move vertically along the vertical supports 212B. The tray lifts 218A, 218B may move between one or more loading positions and a conveying position. In some embodiments, the tray lifts 218A, 218B may be fixedly mounted to the vertical supports 212B. For example, the tray lifts 218A, 218B may be fixedly mounted to the vertical supports 212B at a conveying position.

The conveyors of the tray lifts 218A, 218B are coupled to the body of the tray lifts 218A, 218B. In some embodiments, the conveyors are located within the body of the tray lifts 218A, 218B. The conveyors may protrude at least in part from the housing through one or more openings in the body of the tray lifts 218A, 218B. In some embodiments, the conveyor extend between two rails thereby spanning the distance between two rails defining the body of the tray lifts 218A, 218B.

The cross conveyor 220 is coupled to the vertical supports 212C, as shown in FIG. 2. The cross conveyor 220 is in a conveying position. In some embodiments, the cross conveyor 220 is elevated above the ground. In some embodiments, the cross conveyor 220 is elevated between 8 and 10 feet above the ground. The elevated position of the cross conveyor 220 may advantageously minimize the impact of the system for transferring items from a cart on the floor area.

The transition mechanism 222 is coupled to the vertical supports 212D, as shown in FIG. 2. The transition mechanism 222 extends beyond the conveying position.

The one or more baskets 224A, 224B engage with the transition mechanism 222. The one or more baskets 224A, 224B move between two points. In some embodiments, the top basket 224A moves between a first end of the transition mechanism 222 and the tray content transfer system 204. In some embodiments, the bottom basket 224B moves between the tray content transfer system 204 and the empty source tray collection 808. In some embodiments, the one or more baskets 224A, 224B couple to a lifting mechanism 240B of the vertical supports 212D. The top basket 224A may be used to convey an object from the top of the transition mechanism 222 to the tray content transfer system 204. The baskets 224A, 224B include one or more conveyors configured to move the tray 226 between the transition mechanism 222 and the tray content transfer system 204. In some embodiments, the transition mechanism 222 comprises a mechanical arm configured to push the tray 226 off of the basket 224A, and into the tray content transfer system. The bottom basket 224B may be used to move objects from the tray content transfer system 204 to the empty source tray collection 208.

In some embodiments, the docking station 210, the tray lifts 218A, 218B, and the vertical supports 212A, 212B are encased in a barrier such as plexiglass.

The conveyors of the docking station 210, the tray lifts 218A, 218B, the cross conveyor 220, and the transition mechanism 222 are configured and sized to receive trays 226. In some embodiments, the conveyors of the docking station 210, the tray lifts 218A, 218B, the cross conveyor 220, and the transition mechanism 222 may share identical dimensions, such as width. Alternatively, the conveyors of the docking station 210, the tray lifts 218A, 218B, the cross conveyor 220, and the transition mechanism 222 may have individualized dimensions. For example, FIG. 2 shows the widths of the conveyors of the one or more platforms 214, the plurality of arms 216, tray lifts 218a, 218B, and the cross conveyor 220 vary depending on their function and orientation in the source tray intake system 202.

The intake flow path is defined by the combined conveyors of the docking station 210, the tray lifts 218A, 218B, the cross conveyor 220, and the transition mechanism 222 as described above.

The conveying direction of the docking station 210 is defined by the conveying directions of the conveyors of the one or more platforms 214 and of the plurality of arms 216. The conveyors of the one or more platforms 214 and the plurality of arms 216 share a conveying direction and actuate in the same direction. The conveying direction of the docking station may start from the distal end of the plurality of arms 216 to the platforms 214.

The conveyor of each arm 216 may be individually controlled such that the plurality of arms 216 can be actuated singularly one at a time, collectively by row, or collectively by array. In some embodiments, the plurality of arms 216 are actuated by platform 214—first actuating horizontally along the platform 214 and then vertically to a subsequent platform 214. For example, the arms 216 may be actuated left to right and platform by platform from the top platform 214 to the bottom platform 214 such that only one arm 216 is activated at a time. For example, an arm 216 positioned adjacent to an actuating arm 216 may only activate in response to the conclusion of the actuating arm's 216 actuation. In some embodiments, the first arm 216 to actuate may be positioned at a distal end of an end platform 214. For example, the first arm 216 to actuate may be positioned at the left-most end of the top platform 214. The arm 216 positioned immediately to the right of the left-most arm 216 may only be activated in response to the conclusion of the left most arm's 216 actuation. This process may continue until each arm 216 has been activated. In some embodiments, the plurality of arms 216 may be activated in any order according to user-defined algorithms as discussed in greater detail below.

The conveyors of the one or more platforms 214 align with the conveyors of the plurality of arms 216. As shown in FIG. 2, the conveyors are aligned and configured for conveying an object from the distal end of each of the arms 216, along the length of the arms 216, and to the conveyors of the one or more platforms 214.

The conveying direction of all tray lifts 218A, 218B may be the same. The conveying direction of the tray lifts 218A, 218B may start at the first end and end at the second end. The conveying direction of the tray lifts 218A, 218B may be perpendicular to the conveying direction of the docking station 210.

The conveying direction of the cross conveyor 220 starts at the first end and end at the second end. The conveying direction of the cross conveyor 220 may be the same as the conveying direction of the docking station 210. The conveying direction of the cross conveyor 220 may be perpendicular to the conveying direction of the tray lift 218A, 218B. The side rails prevent an object from rotating. The distance between the side rails and/or protective barrier may be smaller than a dimension of an object. The conveying directions of the docking station 210 and the cross conveyor 220 may be the same. The conveying directions of the tray lifts 218A, 218B may be orthogonal to the conveying directions of the docking station 210 and the cross conveyor 220. The conveying direction of the transition mechanism 222 may be orthogonal to each of the conveying directions of the docking station 210, the tray lifts 218A, 218B, and the cross conveyor 220.

The conveying direction of the transition mechanism 222 may start at the first end and end at the second end. The conveying direction of the transition mechanism 222 may be in the vertical direction. In some embodiments, the conveying direction of the transition mechanism 222 may be linear. In some embodiments, the conveying direction of the transition mechanism 222 may be helical. The cross conveyor 220 may share a height with the tray content transfer system 204. In such embodiments, the conveying position shares the same height with the tray content transfer system 204. In such embodiments, the transition mechanism 222 is unnecessary since the objects need not be lowered to the tray content transfer system 204.

As shown in FIG. 2, the second end of the docking station 210 is functionally adjacent to the tray lifts 218A, 218B when the tray lifts 218A, 218B are in a loading position, the second end of the tray lifts 218A, 218B are functionally adjacent to the first end of the cross conveyor 220 when the tray lifts 218A, 218B are in a conveying position, and the second end of the cross conveyor 220 is functionally adjacent to the first end of the transition mechanism 222 such that the cross conveyor 220 is positioned between the one or more tray lifts 218 and the transition mechanism 222. Accordingly, the output of the conveyor of the plurality of arms 216 is the input of the conveyor of the tray lift 218A, 218B; the output of the conveyor of the tray lifts 218A, 218B is the input of the conveyor of the cross conveyor 220; the output of the cross conveyor 220 is the input of the transition mechanism 222; and the output of the transition mechanism 222 is the input to the tray content transfer system 204 and/or the empty source tray collection 208. The inverse is also possible when the conveyors are operated in reverse. In some embodiments, the transition mechanism 222 may not be included such that the cross conveyor 220 outputs directly to the tray content transfer system 204.

The one or more trays 226 may be placed on the plurality of arms 216 to begin the process of transporting the trays from a source tray intake system 202 to a tray content transfer system 204 along the intake flow path 203. Accordingly, the plurality of arms 216 output the one or more trays 226 to the one or more platforms 214; the one or more platforms 214 output the one or more trays 226 to the tray lift 218A, 218B; the tray lifts 218A, 218B output the one or more trays 226 to the cross conveyor 220, as shown in FIG. 2; the cross conveyor 220 outputs the one or more trays 226 to the baskets 224 of the transition mechanism 222; the transition mechanism 222 outputs the one or more trays into the tray content transfer system 204; the tray content transfer system 204 transfers the contents of the one or more trays 226 to another tray and outputs the one or more trays 226 to the empty source tray collection 208. The tray content transfer system 204 outputs the transferred contents of the one or more trays 226 to the processing apparatus 206. In some embodiments, the transition mechanism 222 is not included such that the cross conveyor 220 outputs the one or more trays 226 directly to the tray content transfer system 204.

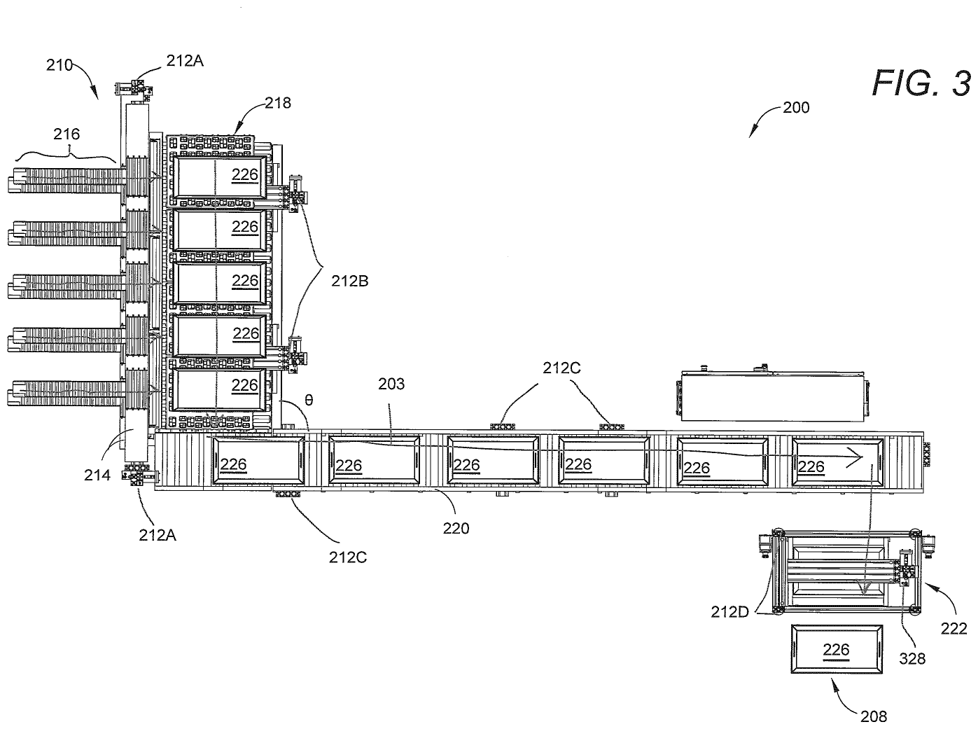

FIG. 3 illustrates a top view of the tray processing system 200 having an intake flow path 203 wherein the conveying direction of the docking station 210 is orthogonal to the conveying direction of the tray lift 218 which are in turn orthogonal to the conveying direction of the cross conveyor 220.

The orientation of the cross conveyor 220 with respect to the tray lift 218 may affect how trays 226 move or rotate when transferred from the tray lift 218 to the cross conveyor 220. The severity or likelihood of trays 226 rotating as they are conveyed from the tray lift 218 to the cross conveyor 220 follows sine relationship where when the angle θ is 90 degrees the sine is at its maximum and when the angle θ is 0 degrees the sine is at its minimum wherein the angle θ is measured between the tray lift 218 and the cross conveyor 220. Accordingly, the possibility for rotation of the trays 226 is most likely when the cross conveyor 220 is oriented orthogonally to the tray lift 218 as shown in FIG. 3. In other embodiments, the angle between the tray lift 218 and the cross conveyor 220 may be reduced and in some embodiments eliminated by aligning the tray lift 218 with the cross conveyor 220 such that the intake flow path 203 is linear between the tray lift 218 and the cross conveyor 220.

The rotational movement of the trays 226 may be exacerbated with a difference in linear speeds between the conveyors of the tray lift 218 and the cross conveyor 220. For example, if the cross conveyor 220 conveys at a faster linear speed than the tray lift 218, then the first end of the tray 226 will begin moving along the cross conveyor 220 before the tray 226 is fully transferred from the tray lift 218 thereby rotating the tray 226. By comparison, if the tray lift 218 conveys significantly faster than the cross conveyor 220, then the tray 226 will not rotate as significantly. However, conveying the tray lift 218 at a higher rate of speed than the cross conveyor 220 may result in a backup of trays 226. The trays 226 may be offloaded onto the cross conveyor 220 faster than the cross conveyor 220 can move the preceding tray 226. Accordingly, it is advantageous to convey the tray lift 218 and the cross conveyor 220 at the same rate of speed and to implement a protective barrier to prevent rotation.

In some embodiments, the cross conveyor 220 includes side rails and/or protective barriers. The distance between the side rails and/or protective barriers is smaller than a dimension of the trays 226. Accordingly, even if cross conveyor 220 is positioned perpendicular to the tray lift 218, the trays are unable to rotate. Additionally and/or alternatively, the cross conveyor 220 may include a driven section and a free rotation section. The driven section may be driven by a motor. The free rotation section may have freely rotating rollers. The free rotation section may use the inertia of the tray to convey the tray to the convey the trays to the transition mechanism 222.

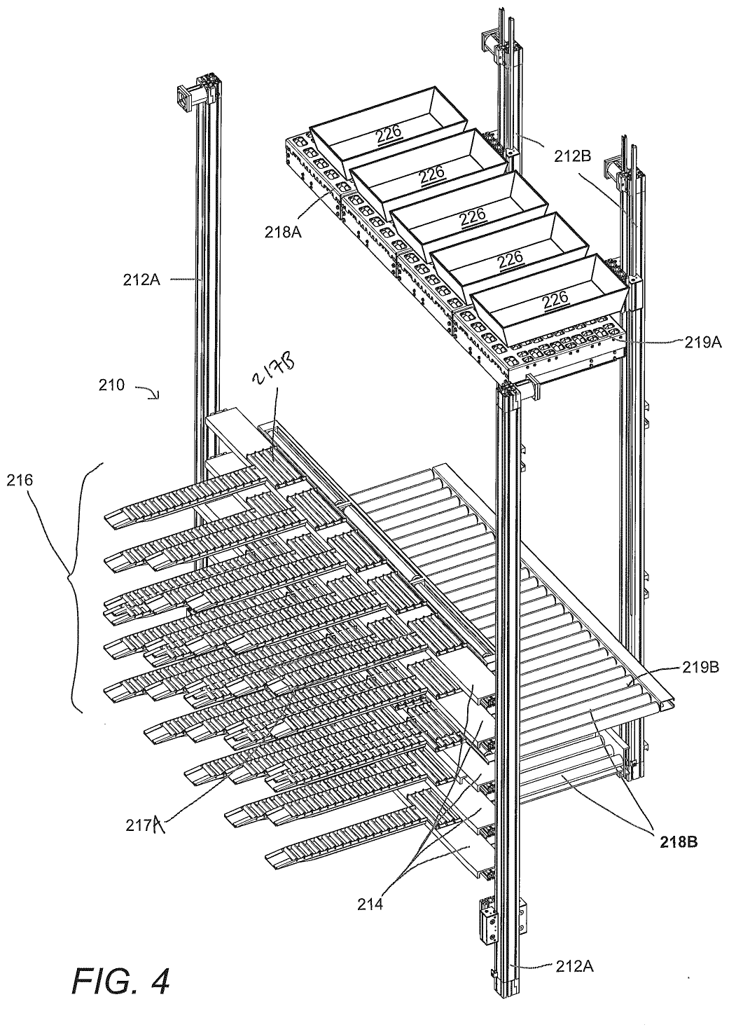

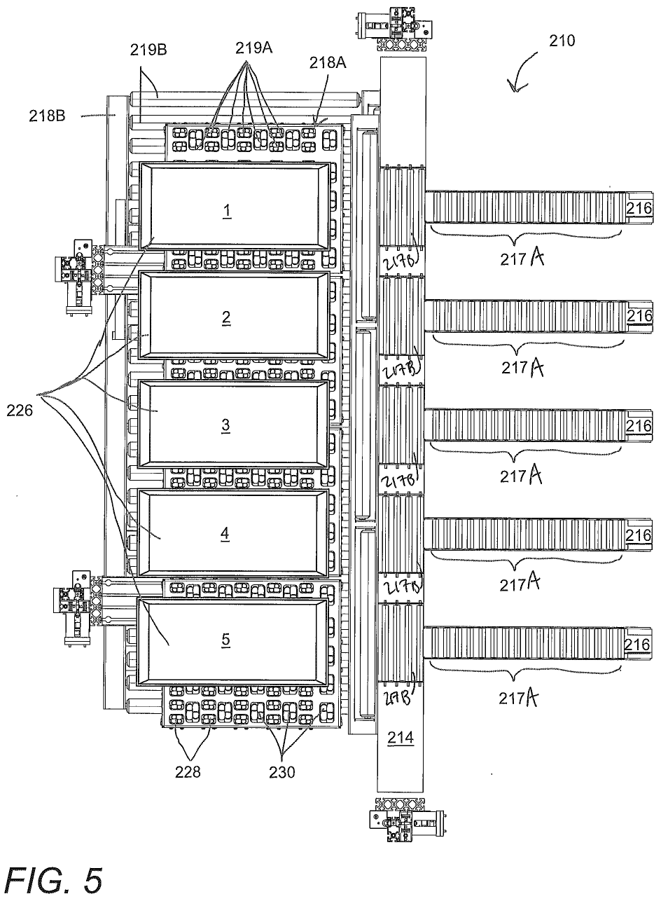

FIGS. 4-5 illustrate the beginning portions of the source tray intake system 202 including the vertical supports 212A, 212B, the docking station 210 and the tray lifts 218A, 218B.

FIG. 4 illustrates a docking station 210 comprising twenty-five arms 216 organized in a 5×5 matrix extending from five platforms 214 and three tray lifts 218A, 218B. The plurality of arms 216 and platforms 214 further include conveyors 217A, 217B. The tray lifts 218A, 218B further include conveyors 219A, 219B.

The conveyors 217A, 217B physically transfer physical objects such as trays 226 from a first location to a second location. For example, the conveyors 217A, 217B transfer the trays 226 along the arms 216 to the tray lifts 218A, 218B when the tray lifts 218A, 218B are aligned with the arms 216. The conveyors 219A, 219B of the tray lifts 218A, 218B transfer the trays 226 along the tray lifts 218A, 218B when the tray lifts 218A, 218B are aligned with a cross conveyor.

The conveyors 217A, 217B, 219A, 219B may be any device known in the art for moving an object from one location to another and may be any of the conveyors described above. For example, the conveyors 217A, 217B may be driven rollers, the conveyors 219A may be omni- or multi-directional rollers, and the conveyors 219B may be driven rollers, as shown in FIG. 4. The conveyors 219A, 219B may be the same.

The docking station 210 is movably mounted to the vertical supports 212A via the platforms 214. The tray lifts 218A, 218B are movably mounted to the vertical supports 212B and are configured to move along the vertical supports 212B between one or more loading positions and a conveying position.

The conveying position corresponds to the height of the cross conveyor. The one or more loading positions correspond to a height of a respective platform 214. In some embodiments, there are as many loading positions as platforms 214. In some embodiments, the number of loading positions may correspond to the number of rows of a transport vehicle. Accordingly, FIG. 4 illustrates a single conveying position and five loading positions. The vertical supports 212B extend above the conveying position. Extending the vertical supports 212B beyond the conveying position advantageously allows the bottom most tray lift 218A, 218B to reach the conveying position without being blocked by the upper tray lifts 218A, 218B. As shown in FIG. 4, the tray lifts 218B are aligned with two platforms 214.

FIG. 5 illustrates a top view of the docking station 210 including a row of five arms 216 extending from a platform 214 aligned with a tray lift 218. The conveyor 217A, 217B of the arms 216 and platform 214 and the conveyor 219A of the tray lift 218A are shown to be aligned such that a tray 226 may be transferred from one or more arms 216 onto the tray lift 218A. In some embodiments, the tray lift 218A may comprise a conveyor 219A capable of transferring the trays 226 back onto the arms 216. In such embodiments, the conveyor 219A of the tray lift 218A may comprise both a plurality of parallel rollers 228 and orthogonal rollers 230 wherein the parallel rollers 228 provide movement in the same direction as the conveyors 217A, 217B of the arms 216 and platform 214 whereas the orthogonal rollers 230 provide movement orthogonal to the conveyors 217A, 217B.

The trays 226 are positioned in a conveying order on the tray lift 218A. The conveying order is the order in which the trays 226 are conveyed and transported to the tray content transfer system 204 along the intake flow path 203. The conveying order may comprise “X” number of trays in an order ranging from a first conveying position to an “Xth” conveying position. In some embodiments, the number of conveying positions may correspond to the number of arms 216 on each platform 214. For example, a docking station 210 including five arms 216 on each platform 214 may define five conveying positions. The five conveying positions may include a first conveying position 1, a second conveying position 2, a third conveying position 3, a fourth conveying position 4, and a fifth conveying position 5, as shown in FIG. 5. The first conveying position corresponds to the tray 226 to be conveyed to the tray content transfer system 204 first. The “Xth” conveying position corresponds to the tray 226 to be conveyed to the tray content transfer system 204 last. The conveying positions may run sequentially with the first tray position nearest the cross conveyor. The tray lift 218A, 218B may have corresponding tray positions for each conveying position. For example, the tray lift 218A, 218B may have five tray positions for a conveying order having five trays 226. The tray positions may run sequentially with the first tray position nearest the cross conveyor.

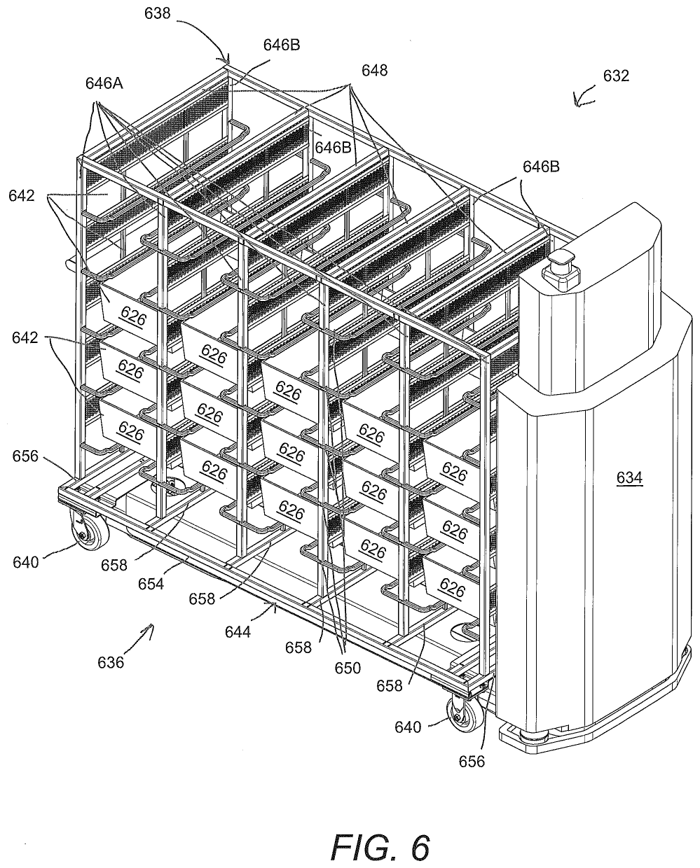

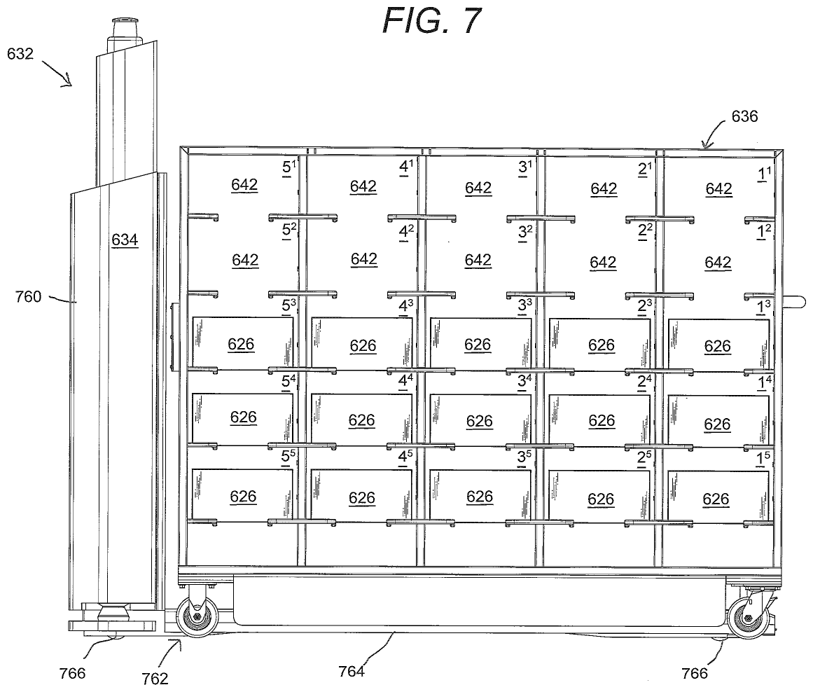

FIGS. 6-7 illustrate a transport vehicle 632 including two primary components: a driver 634 and a cart 636. The cart 636 further includes a frame 638 supported on a plurality of wheels 640. The frame 638 includes a plurality of cells 642, a base 644, a plurality of vertical support beams 646A, 646B, a plurality of horizontal supports 648, and a plurality of tray holders 650.

The driver 634 is a controllable, movable device. The driver 634 includes wheels, handles, and/or electronics such as a processor and memory. In some embodiments, the driver 634 provides means for moving the cart 600 as discussed in greater detail below. In some embodiments, the driver 634 is configured for autonomous operation within a distribution facility. The driver 634 controls the transport vehicle 632 in response to sensor input, requests from vehicle control systems, and the like. The driver 634 can be configured to detect, or receive a summon call to position itself proximate the arms 216 of the tray processing system 200. In some embodiments, the drive 634 is configured to position itself at a tray loading location (not shown) as trays 626 are loaded onto the cart, the trays containing items to be sorted in the item processing equipment or sorting device serviced by the tray processing system 200. When the driver 634 detects the transport vehicle is full of trays 626, the driver 634 automatically moves the cart to the tray processing system 200 for unloading.

The cart 636 is defined by the structural integration of the frame 638, the wheels 640, the base 612, the vertical support beams 646A, 646B, the plurality of horizontal supports 648. The cart 636 is configured to receive a plurality of trays 226. The cart 636 may further include a suite of sensors. The suite of sensors may include a laser sensor such as a 3D laser scanning system (“LIDAR”), RFID scanners, or optical sensors such as cameras. In some embodiments, the scanners may be configured to scan the environment. The scanned environment may be mapped and used to calculate pathways to a desired destination. Additionally and/or alternatively, the suite of sensors may locate obstacles or hazards such as humans, spills, debris, or waste. In some embodiments, the scanners may be configured to scan the contents of the cells 642. The scanners may be used to identify the contents of the cells 642 as discussed in greater detail below.

The frame 638 is defined by the base 644, the plurality of vertical support beams 646, and the plurality of horizontal supports 648. The frame 606 forms the exterior structural support for the cart 636.

The plurality of wheels 640 may be unidirectional, multidirectional such as swivel casters, or a combination of both. In some embodiments, the transport vehicle 632 comprises four multidirectional swivel casters such that the transport vehicle 632 is advantageously capable of moving in multiple directions without changing the orientation of the transport vehicle. The plurality of wheels 640 may be driven and controlled by a processor and memory or may be free moving. This allows the transport vehicle 632 to align the array of cells 642 with a target array at target destination by approaching along a parallel path, and then approach the target array in an orthogonal path as discussed in greater detail below.

The cells 642 are substantially rectangular prism shaped. The cells 642 are defined by the space between two adjacent vertical support beams 646 and two adjacent tray holders 650. The cells 642 may be sized to receive a tray 226, such as a source tray or processing tray, or other box-shaped objects. The plurality of cells 642 may be organized in an array or matrix. In some embodiments, the plurality of cells 642 may be organized in an A×B matrix having “A” number of rows and “B” number of columns. Each cell 642 may be outfitted with a barcode reader, a laser scanner, an optical sensor such as a camera, or a Radio Frequency Identification (RFID) and/or Near Field Communication (NFC) scanner for scanning machine-readable codes or tags including NFC or RFID tags. Additionally and/or alternatively, each cell 642 may include a scale or other sensor. The scale or other sensor may detect the presence of a tray 626, or lack thereof. Furthermore, the scale and/or sensor may measure whether a tray 626 includes any contents.

The base 644 provides support for the transport vehicle 632. The base 644 further includes two sets of links: a first set 654 and a second set 656, and a plurality of cross beams 658. In some embodiments, the base 644 may be a rectangular shape oriented along a horizontal plane further wherein the two sets 654, 656 are orthogonal to one another such that a right angle separates two coupled links, and wherein links of the first set 654 are parallel to each other and of equal length and the links of the second set 656 are parallel to each other and of equal length. The links of both sets 654, 656 may be of equal length. Alternatively, the length of adjacent links may have different lengths as shown in FIG. 6. Furthermore, in some embodiments, the length of the links of the first set 654 extending in the longitudinal direction of the cart 636 may be longer than the links of the second set 656. The cross beams 658 extend between the links of the first set 654 and are equally spaced between the links of the second set 656. The cross beams 658 may be located along the length of the links of the first set 654 corresponding to the width of the columns of cells 642. Advantageously, cross beams 658 provide lateral structural support to the base 644 and can provide further support for vertical support beams 646 as discussed below.

The vertical support beams 646A, 646B are linear support beams. The vertical support beams 646A, 646B include a superior end and an inferior end. Advantageously, the vertical support beams 646A, 646B provide structural support to the frame 606 by acting as a support column for transmitting loads experienced by the cells to the base 644.

The horizontal supports 648 are linear support beams. The horizontal supports 648 may be formed from the same material as the vertical support beams 646A, 646B. The horizontal supports 648 include two ends. Advantageously, the horizontal supports 648 provide structural support to the frame 606 by acting as a support beam for transmitting loads experienced by the cells 642.

The tray holders 650 may be any support structure capable of supporting a tray 226 or other box structure. For example and without limitation, in some embodiments, the tray holders 650 may be a bolt, a shelf, a platform, a ledge, a tubular rod, or resting position. In some embodiments, the tray holders 650 may be “U” shaped rods. The “U” shaped rods may be oriented along a horizontal plane, as shown in FIG. 6.

The vertical support beams 646A, 646B extend vertically from the base 644. The vertical support beams 646A, 646B are aligned along two parallel planes. In some embodiments, the vertical support beams 646A, 646B have equal length. The inferior ends of the vertical support beams 646A, 646B couple to the base 644. The superior ends of the vertical support beams 646A, 646B are located at the end opposite the base 644. The vertical support beams 646A, 646B may extend from the links of the first or second sets 654, 656, from the cross beams 658, or both. For example, in some embodiments, the vertical support beams 646A, 646B may extend from the cross beams 658 and the links of the second set 656 as shown in FIG. 6. Alternatively, the vertical support beams 646A, 646B may extend solely from the links of the first set 654. In such embodiments, the vertical support beams 6646A, 646B may extend from a location along the links of the first set 654 corresponding to a location where the cross beams 658 couple to the links of the first set 654 such that the vertical support beams 646A, 646B and cross beams 658 are orthogonal to one another.

The horizontal supports 648 span between two vertical support beams 646A, 646B. In some embodiments, the horizontal supports 648 may be organized in sets aligned along a horizontal plane. For example, as shown in FIG. 6, the horizontal supports 648 are shown organized in a set aligned along a horizontal plane located at the superior ends of the vertical support beams 646A, 646B. Furthermore, the horizontal supports 648 may extend between two vertical support beams 646A, 646B belonging to two different parallel planes. Accordingly, the frame 606 may comprise one horizontal support 648 for every two vertical support beams 646A, 646B (one from each parallel plane) or may comprise the same number of horizontal supports 648 as the base 644 comprises cross beams 658. Additionally, the horizontal supports 648 may be parallel with and located above the cross beams 658. Alternatively, the horizontal supports 648 may be positioned anywhere between the inferior and superior ends of the vertical support beams 646. Accordingly, there may be multiple sets of horizontal supports 648 aligned along several horizontal planes along the length of the vertical support beams 646. In some embodiments, each vertical support beam 646A, 646B may comprise the same number of horizontal supports 648 as the frame 606 has rows of cells 642. Advantageously, the horizontal supports 648 provide lateral structural support to the frame 606 by acting as a moment frame, shear wall, or braced frame and prevents sideways movement, buckling, or other forms of failure in the vertical support beams 646A, 646B. Accordingly, one of ordinary skill in the art would understand how to decide how many horizontal supports 648 to provide in the frame 606 and where to place them for providing adequate strength to the transport vehicle 632.

The tray holders 650 couple to one or more vertical support beams 646A, 646B and protrude into a space between two or more vertical support beams 646A, 646B defining a volume, or cell 642. Each tray holder 650 may span between two vertical support beams 646A, 646B from different planes. The “U” shaped tray holder 650 may be configured such that the bottom of the “U” shape is centrally positioned within the cell 642. The bottom of the “U” shape may be the distance between the two vertical support beams 646A, 646B. In some embodiments, two tray holders 650 may be used in one cell 642. In such embodiments, the two tray holders 650 may be inversely oriented. For example, two tray holders 650 may span between two sets of vertical support beams 646A, 646B from different parallel planes, respectively. The tray holders 650 may protrude toward one another into a space between the two sets of coupled vertical support beams 646A, 646B, as shown in FIG. 6. Accordingly, the cell 642 may be defined by the space laterally between four vertical support beams 646A, 646B and longitudinally between two tray holders 650. In some embodiments, the tray holders 650 couple to a single vertical support beams 646A, 646B and protrude into a space between three neighboring vertical support beams 646A, 646B such as a bolt coupled to a vertical support beam 646A, 646B and angled to enter the cell at an angle between 0 and 90 degrees. The tray holders 650 may be coupled with the vertical support beams 646A, 646B by any means known in the art including mechanical fixtures such as screws, bolts, nuts; welding; adhesives; magnets; or a notched vertical support beam 646A, 646B into which the tray holder may slide.

The transport vehicle 632 may have one fewer column of cells 642 than there are vertical support beams 646. The transport vehicle 632 may have the same number of rows of cells 642 as tray holders 650 extending from a vertical support beam 646. In some embodiments, the transport vehicle 632 has the same number of cells 642 as a docking station has arms. Moreover, in some embodiments, the transport vehicle 632 may comprise the same matrix of cells 642 as the docking station's matrix of arms. For example, the transport vehicle 632 may include a 5×5 matrix of cells 642 corresponding to a 5×5 matrix of arms of the docking station. By comparison, the transport vehicle 632 may include more or fewer cells than the docking station has arms. For example, the transport vehicle 632 may comprise a 5×5 matrix of cells while a docking station has one row of five arms.

In some embodiments, the transport vehicle 632 may carry trays 626 containing partially sorted items from a first sorting process and may transport the partially sorted items to a second sorting process for further processing. In such embodiments, the placement and organization of trays 626 within the cells 642 of the transport vehicle 632 is known to facilitate efficient offloading of the trays 626 onto a docking station. Otherwise, the items may be misplaced, or missorted by unloading the partially sorted items into the source tray intake process in the wrong order. Accordingly, each cell 642 is linked or associated with the particular contents of a corresponding tray 826.

The trays 626 may be any container, tray, or bin sized to fit within the cells 642 of the transport vehicle 632 and capable of carrying items such as letters, flats, or other parcels. For example, the trays 626 may be soft-sided source trays made of cardboard or thin plastic. Alternatively, the trays 626 may be hard-sided processing trays made of plastic or other sturdy materials. The trays 626 may be the same as the trays 226 described above.

In some embodiments, the trays 626 may include a unique machine-readable code such as a bar code or QR code. In other embodiments, the trays 626 are outfitted with a unique digital key such as NFC or RFID tags. In such embodiments, each tray 626 may be scanned after the partially sorted items have been placed onto the tray 626 thereby linking or associating the loaded items to a particular tray 626. When the tray 826 is placed into a cell 642, the cell 642 is associated with the contents of the corresponding tray 626. In some embodiments, the cell 642 may scan the machine-readable code or tag on the tray 626 thereby linking or associating the cell 642 with the particular items contained within the tray 626. Furthermore, the data associating the contents of the tray 626 may be tracked by a computing device located either within the transport vehicle 632 or remotely and being accessible via wireless communications. Accordingly, the system is conscious of the contents of each cell 642. Scanning the trays 626 can also send a signal to an item tracking system to update the records of the items indicating the scan event and the location as being on the transport vehicle 632.

Additionally and/or alternatively, the transport vehicle 632 may comprise a single scanner for scanning the bar codes, the QR codes, the RFID tags, or the NFC tags of all trays 626. Accordingly, each tray 626 may be scanned, identifying the tray 626 and its contents. Each tray 626 is then subsequently placed in a cell 642 wherein the scale or other sensor identifies in which cell 642 the tray 626 was placed. Accordingly, whether the trays 626 are loaded into the cells 642 of the transport vehicle 632 in a particular or discernable pattern (e.g., left to right and top to bottom) or randomly, the contents of the trays 626 may be tracked and offloaded in the correct order. By comparison, in some embodiments, the items of the trays 626 may be wholly unsorted. In some embodiments, some cells 642 may remain empty with only a portion of the array of cells 642 containing a tray 626, as shown in FIG. 6. Accordingly, the cells 642 may be outfitted with scales to measure weight, or other sensors to detect the presence of the trays 626 such that loaded cells 642 are identified, while the contents of the cells 642 remains unknown.

Turning to FIG. 7, a transport vehicle 632 comprising a driver 602 and a cart 636 is illustrated. The driver 634 may further comprise a body 760 and a coupler 762 for engaging with a cart 636, described above.

The body 760 may comprise a plurality of electronic components such as one or more processors and/or controllers, a memory, a wireless data receptor configured to receive data wirelessly, and one or more electric motors. The wireless data receptor may be connected to a local area network (LAN), a wireless local area network (WLAN) such as WI-FI®, or other wireless communication technologies including BLUETOOTH®. The electric motors may be each electrically connected to the one or more processors and/or controllers. In some embodiments, the driver 634 is autonomously driven and controlled. In such embodiments, the electronic components calculate and drive the transport vehicle 632 along a traveling path. The traveling path is a defined path between two or more locations, such as a docking station and a loading station. Furthermore, the traveling path may be optimized to avoid potential hazards such as humans, spills, debris, or waste. Alternatively, the body 760 may not include the electronic components discussed above. Instead, the body 760 may comprise handles. Accordingly, the transport vehicle 632 may be manually pushed and controlled by a human operator.

The coupler 762 may be a mechanical, magnetic, or other mechanism for physically coupling two components together. In some embodiments, the coupler 762 may comprise one or more arms 764 extending from the base of the body 760. In some embodiments the one or more arms 764 may be similar to the forks of a forklift or pallet jack. In such embodiments, the one or more arms 764 may have wheels or rollers 766 embedded within the arms 764. The one or more arms 764 may have a length. The length of the one or more arms 764 may be the same as the longitudinal length of the cart 636. In some embodiments, the one or more arms 764 may be telescopic. In such embodiments, the smaller segments of the one or more arms 764 can retract within larger segments of the one or more arms 764. The distal segments of the one or more arms 764 may be smaller than the proximal segments of the one or more arms 764.

The cart 636 may further include grooves, recesses, or other small spaces set back from the remainder of the base of the cart 636. In other embodiments, the coupler 762 may be located in a plurality of longitudinal locations along the body 760 and may be magnetic or mechanical and configured to engage with a corresponding receptacle on the side of the cart 636.

The coupler 762 links the driver 634 to the cart 636. The coupler 762 may removably couple the driver 634 to the cart 636 such that the cart 636 may be removed from the driver 634.

The one or more arms 764 may be configured to be slidably inserted within a volume of the cart 636.

The grooves, recesses, or other small spaces may be configured to receive the one or more arms 764 of the driver 634, as shown in FIG. 7.

Each cell 642 of the transport vehicle 632 may have a unique identifier associated therewith, and the unique identifier can be affixed to each cell 642. The unique identifier corresponds to the column and row of the cell 642. In some embodiments, unique identifiers may be a column position of the cell 642 in a given row. In some embodiments, the unique identifiers may identify which row the cell 642 is in. The unique identifier is shown in FIG. 7 in a “C^{R}” format. “C” corresponds to the column position of the cell 642 for a given row. “R” corresponds to the row position of the cell 642. In some embodiments, the trays 626 may be stowed in the transport vehicle 632 in a conveying order. The conveying order may go by columns then rows. For example, the first conveying position of any given row may be column position 1 and the last conveying position of any given row may be the last column position, (e.g., column position 5). The first conveying row may be the top row (e.g., row 1) and the last conveying row may be the bottom row (e.g., row 5). Accordingly, the first conveying position of a given row may follow the last conveying position of the preceding row. For example, the tray 626 in the cell 642 in the 1² position may follow the tray 626 in the cell 642 in the 5¹ position. In some embodiments, the unique identifier is encoded in or associated with a computer readable code located on each cell 642. In some embodiments, the unique identifier also includes or is further associated with an identifier for the transport vehicle 632. When an item is placed into a tray 626, in a cell 642, and on a transport vehicle 632, this location can be identified and tracked by reading or scanning the unique identifiers on the cells 642.

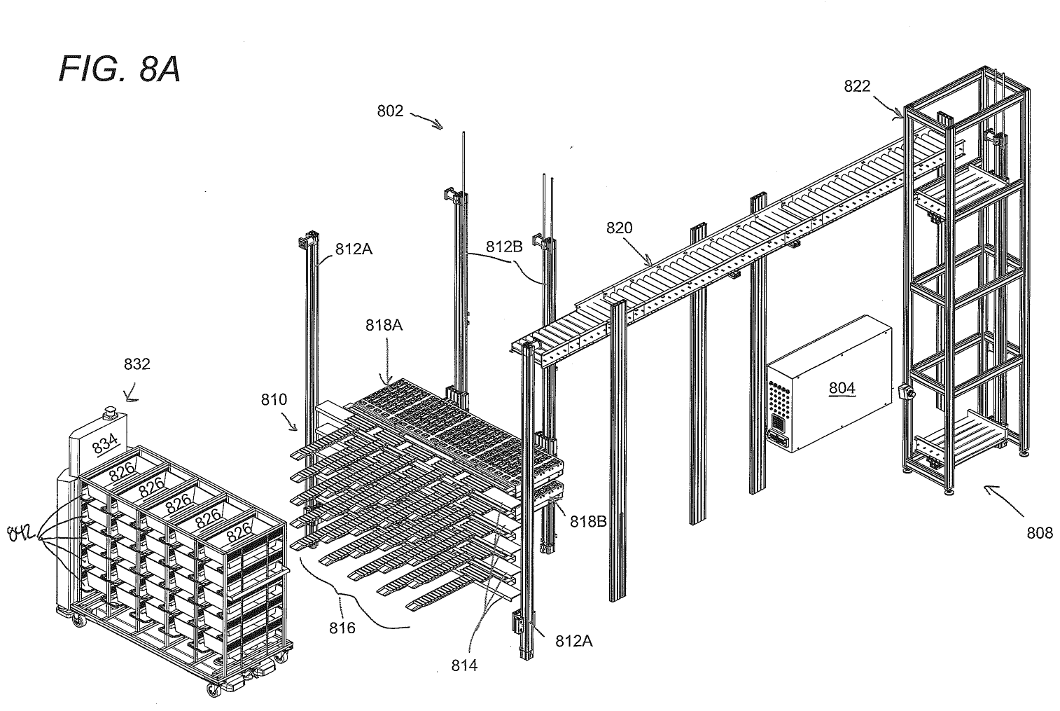

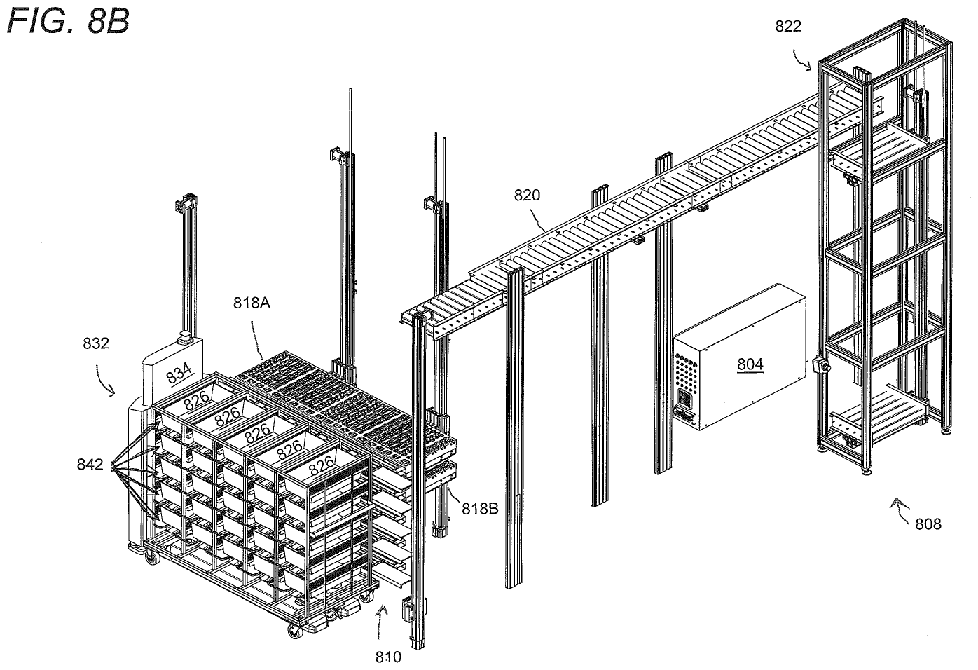

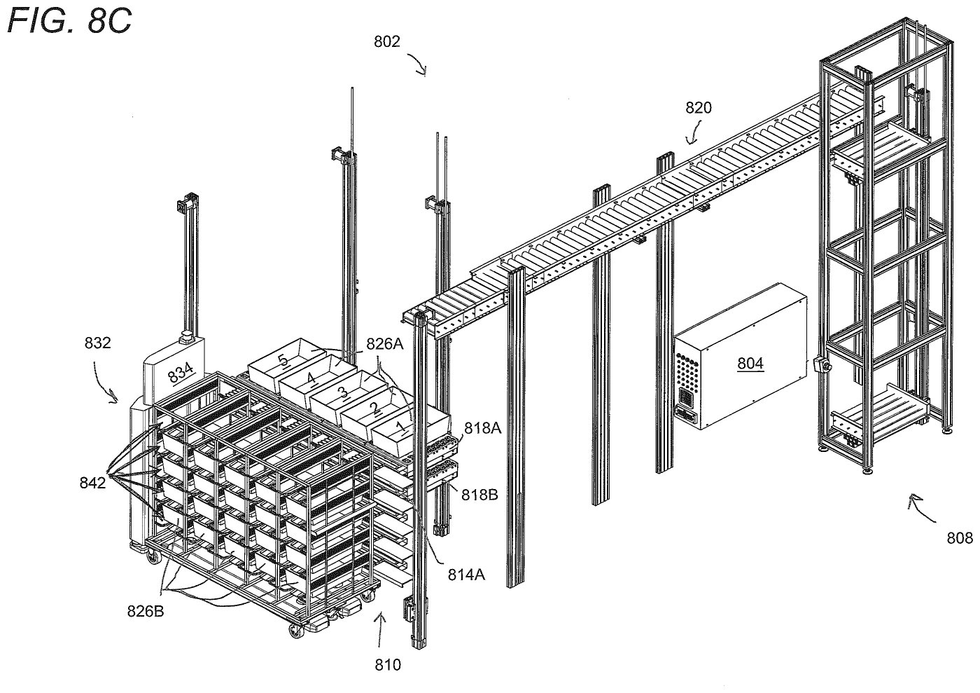

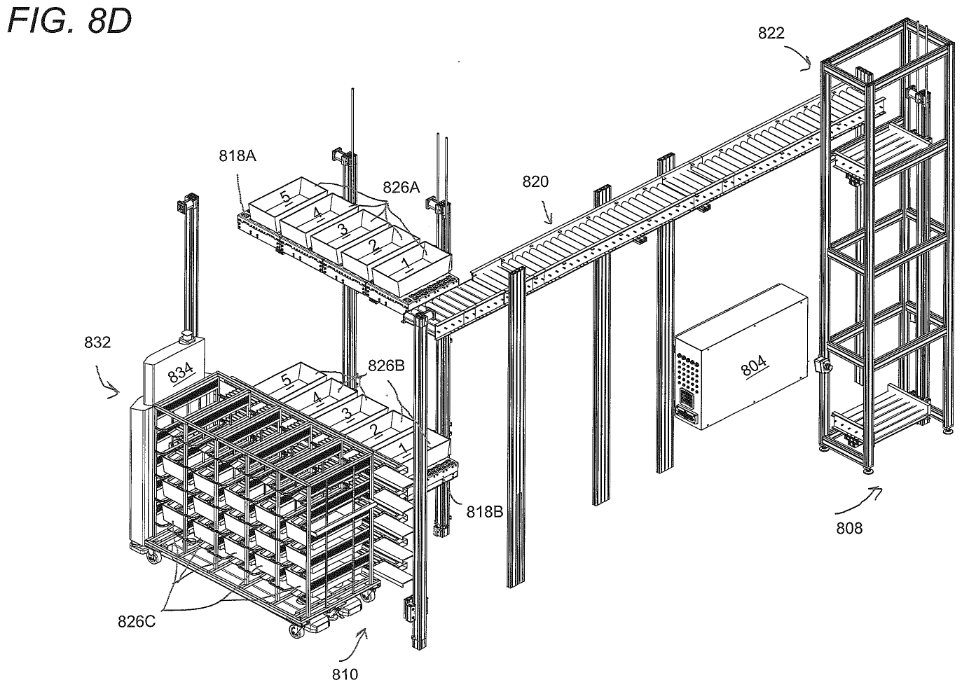

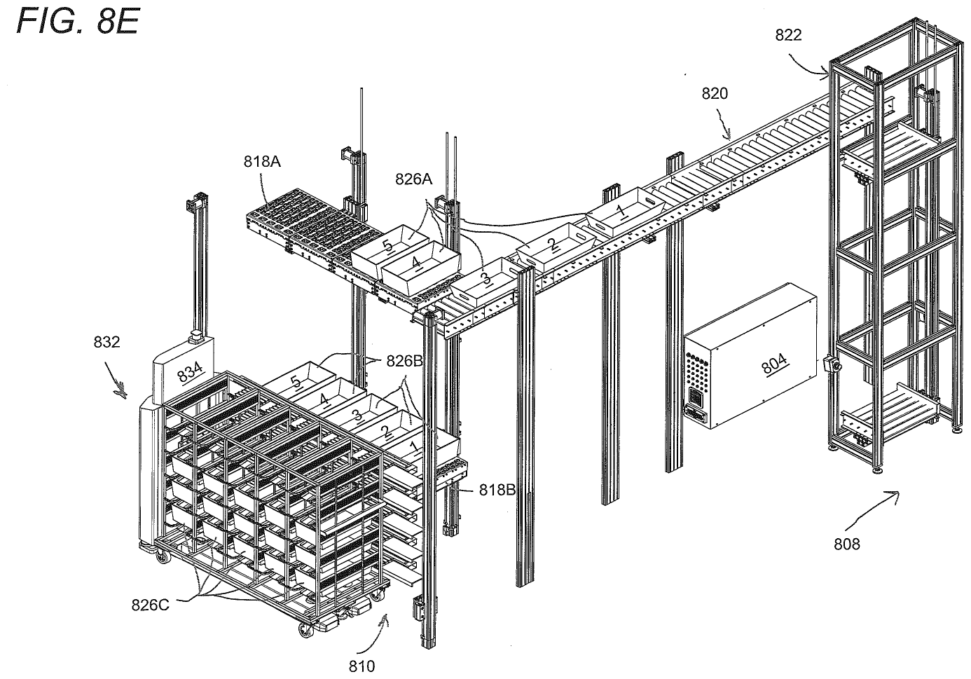

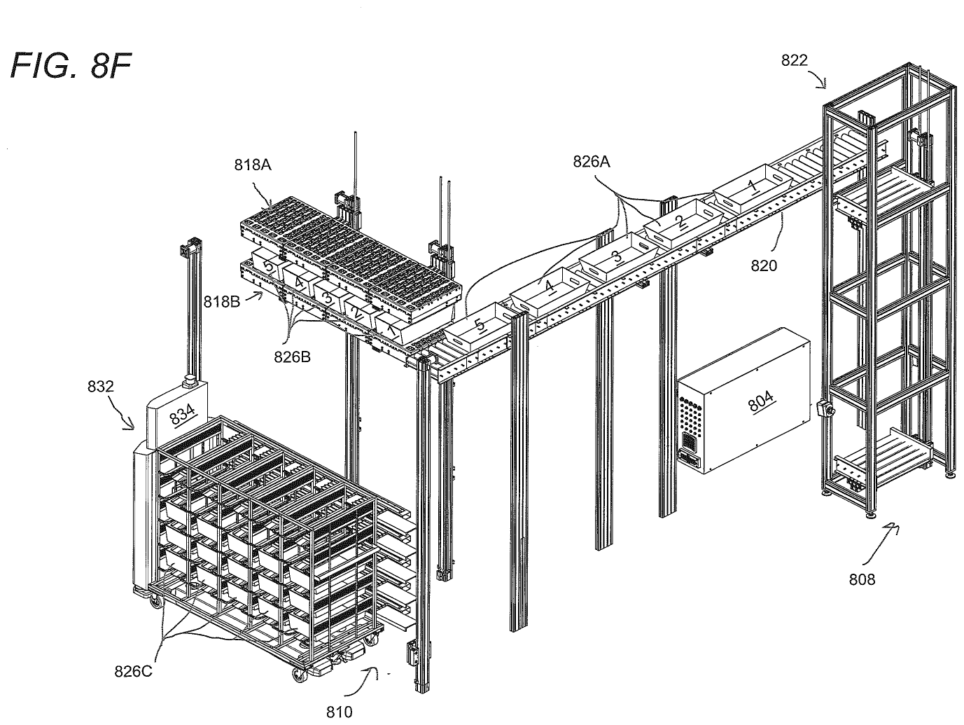

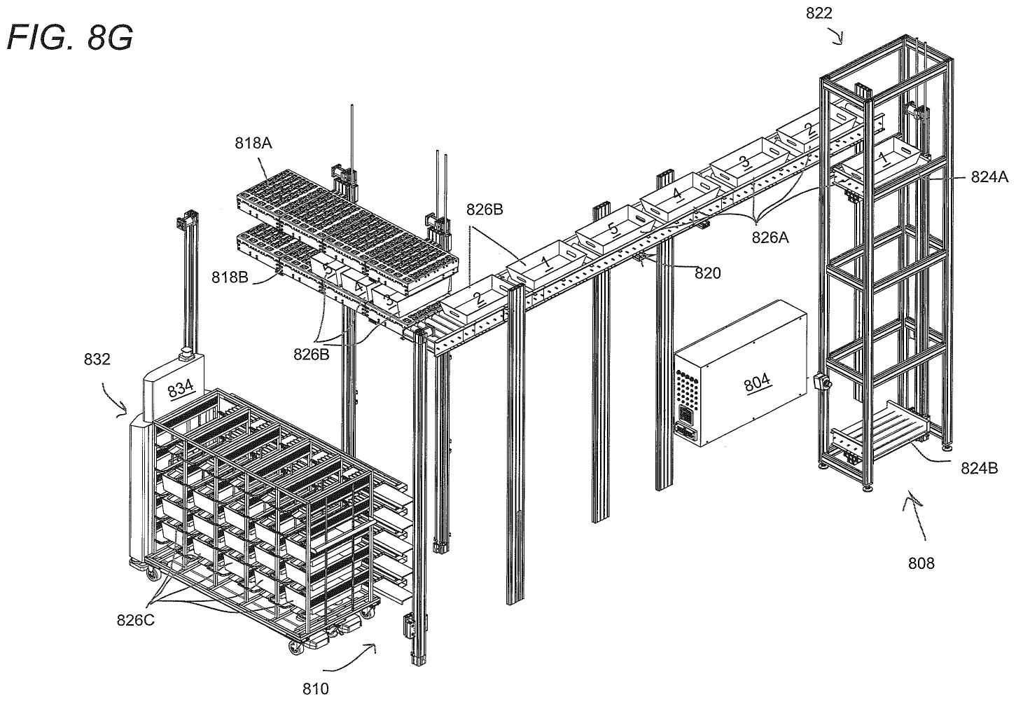

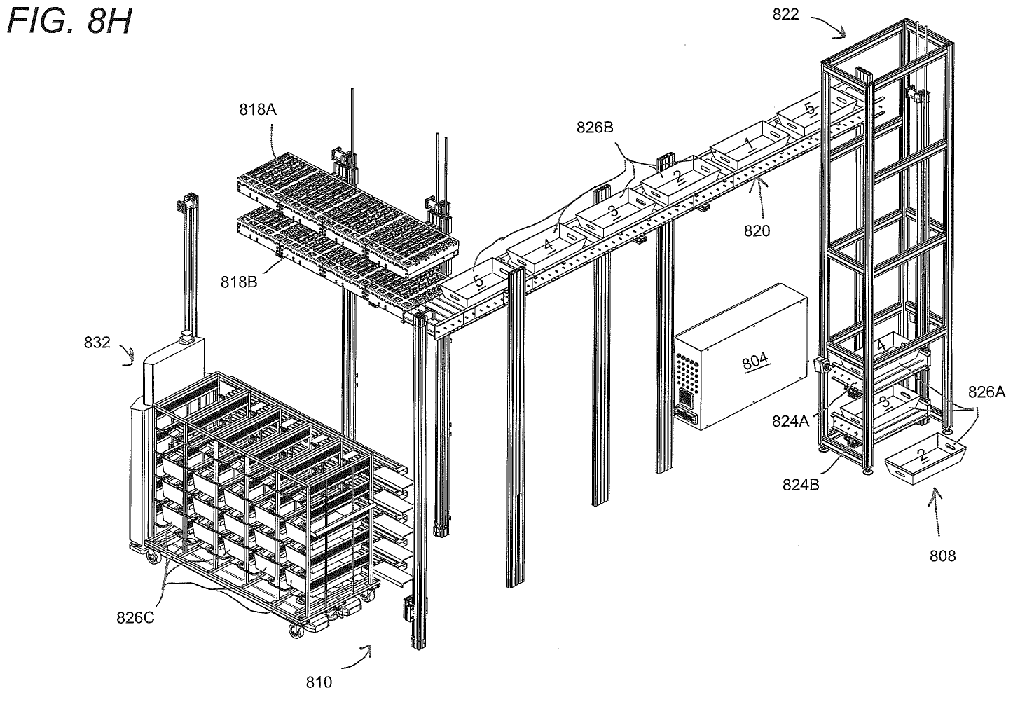

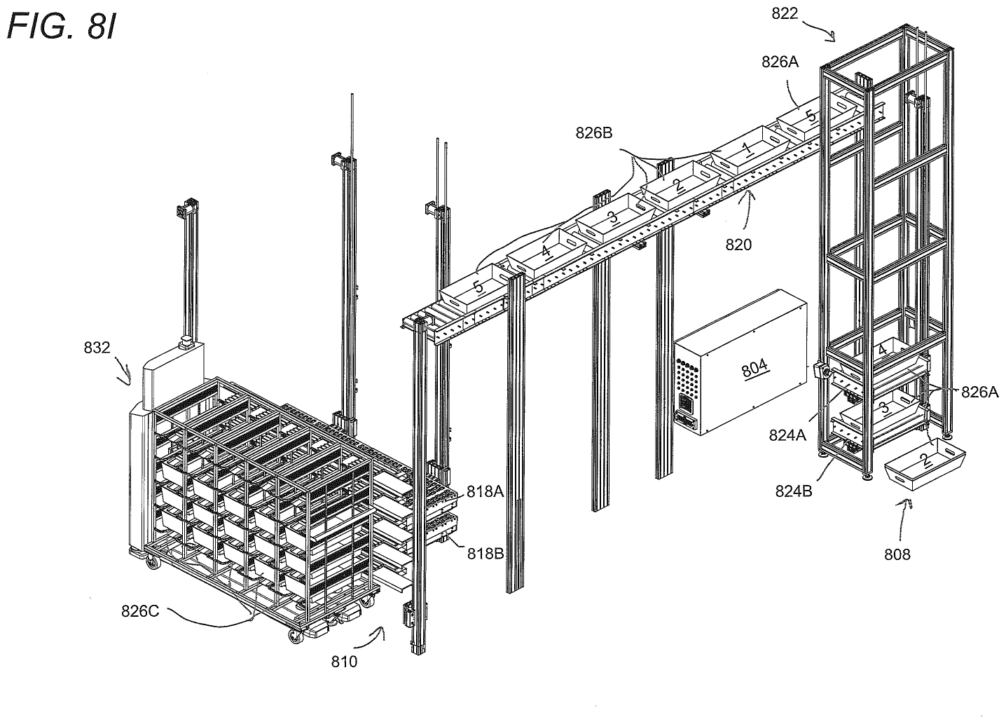

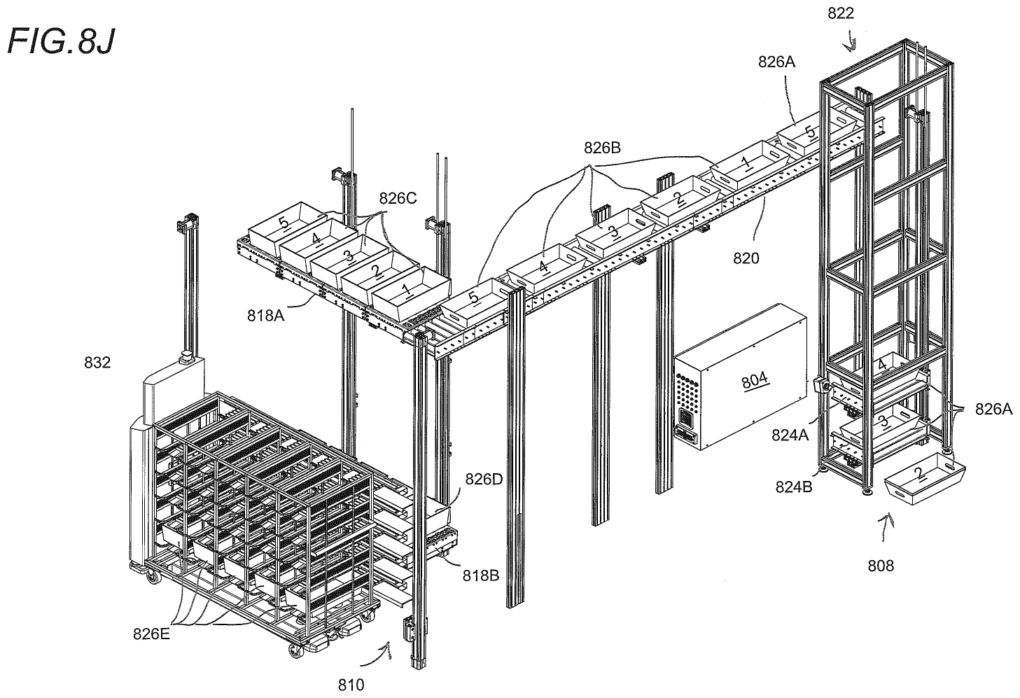

FIGS. 8A-J sequentially illustrate an example process for transferring trays 826 from a transport vehicle 832 to the tray content transfer system 804 via a source tray intake system 802. Although the process of FIGS. 8A-J is shown and described in the context of the source tray intake system depicted in FIG. 2, it will be appreciated that the same or similar steps may be implemented in any other content transfer system. Additionally, like numerals will be used to identify like parts.

FIG. 8A depicts an initial state of the source tray intake system 802. In the initial state, a transport vehicle 832 comprising a plurality of trays 826 organized in an array of cells 842 may approach a proximate location located in front of a docking station 810. The trays 826 are depicted as empty trays for ease of illustration. The trays 826 can be filled or partially filled with distribution items, such as letters, flats, parcels, and the like, which are to be processed on the item processing equipment. The approach may comprise the transport vehicle 832 driving to a location proximate the tray intake system 802, aligning the cells 842 of the transport vehicle 832 with the arms 816 of the docking station 810 by driving the transport vehicle 832 parallel with the docking station 810. The trays 826 may be preprocessed and partially sorted in the initial state or wholly unsorted as discussed above. The transport vehicle 832 may be either autonomously driven or manually pushed to an intake position located adjacent to a docking station 810.

In some embodiments, the one more tray lifts 818A, 818B move vertically along the vertical supports 812B. In such embodiments, the one or more tray lifts 818A, 818B may be in a loading position in the initial state. As shown in FIG. 8A, the number of loading positions corresponds to the number of platforms 814. Each of the tray lifts 818A, 818B share an elevated position with a platform 814 of the docking station 810. For example, in a system having two tray lifts 818A, 818B, the first tray lift 818A may be aligned with the top platform 814 of the docking station 810 and the second tray lift 818B may be aligned with the second platform 814 of the docking station 810, as shown in FIG. 8A. Alternatively, the number of loading positions may correspond to the number of rows of cells 842 in the transport vehicle 832. As shown in FIG. 8A, the docking station 810 includes the same number of platforms 814 as rows of cells 842 in the transport vehicle 832. In some embodiments, the docking station may include a single platform that may move along the vertical supports 812A to offload trays 826 from different rows of cells of the transport vehicle 832.

In some embodiments, the one or more tray lifts 818A, 818B may be in another position in the initial state. For example, the one or more tray lifts 818A, 818B may be elevated such that the second tray lift 818B may be in a conveying position and aligned with the cross conveyor 820 while a first tray lift 818A is elevated above the cross conveyor 820.

In some embodiments, the one or more platforms 814 may be configured to move vertically along the vertical supports 812A. In such embodiments, the source tray intake system 802 may comprise only one tray lift 818A, 818B. The tray lift 818A, 818B may be located in a conveying position adjacent to the cross conveyor 820. In such embodiments, the tray lift 818A, 818B may be fixed to the vertical supports 812B. Each of the one or more platforms 814 may move along the vertical supports 812A and align with the tray lift 818A, 818B to offload trays 826 from the platforms 814 to the tray lift 818A, 818B. In the initial state, the one or more platforms 814 are in a position to receive the transport vehicle 832.

Referring now to FIG. 8B, after the initial state, the transport vehicle 832 comprising a plurality of trays 826 may dock with a docking station 810 of the source tray intake system 802 by driving towards the docking station 810 to an intake position located adjacent to the docking station 810. In some embodiments, the arms of the docking station 810 engage with a corresponding cell 842 of the transport vehicle 832. In some embodiments, the arms slidably insert below each corresponding tray 826 when the transport vehicle 832 is in the intake position. In such embodiments, the conveyors of the arms may be in physical contact with the trays 826. Accordingly, the docking station 810 is aligned with the transport vehicle 832. In some embodiments, the platforms may be in a loading position when aligned with the cells of the transport vehicle 832. The arms are configured to offload the corresponding trays 826. A scanner or sensor at the docking station 810 scans or reads codes on the transport vehicle 832 and/or the trays 826 to identify item service classes, item types, sorting instructions, equipment run priorities, or other indicators which would require unloading trays 826 in a particular order.

In some embodiments, the one or more tray lifts 818A, 818B may be in the same position as they were in the initial state, as shown in FIG. 8B. Alternatively, the one or more tray lifts 818A, 818B may move from the initial position to another position. For example, in embodiments where the second tray lift 818B is initially positioned in a conveying position located adjacent to the cross conveyor 820, the one or more tray lifts 818A, 818B may move down along the vertical supports 812B from their position in the initial state to a loading position adjacent to the platforms 814. This movement may occur simultaneously with the docking of the transport vehicle 832 or after the transport vehicle 832 is docked and ready for unloading. In some embodiments, the one or more tray lifts 818A, 818B may move down along the vertical supports 812A in response to a docking indicator.

The docking indicator may be any electrical, mechanical, computerized, or other response to the docking of the transport vehicle 832 by measuring the transport vehicle 832, the docking station 810, or both. For example, the docking indicator may be an electrical response to one or more sensors. The sensors may be any sensor configured to detect the position. These sensors may be an optical sensor, a laser sensor, LIDAR, or a hall-effect sensor configured to detect either when the transport vehicle 832 is in the loading position. Alternatively, the docking indicator may be a response to a mechanical switch or button activated when the transport vehicle 832 is in the loading position.

FIG. 8C depicts the trays 826A being systemically offloaded from the transport vehicle 832 by the arms of the docking station 810. The trays 826B remain on the transport vehicle 832. The trays 826A correspond to a first batch of trays to be offloaded from the transport vehicle 832. In some embodiments, the trays 826A may correspond to the trays from the top/first row of the transport vehicle 832. The trays 826B, shown in FIG. 8C, correspond to trays remaining on the transport vehicle 832. The trays 826 can be unloaded systematically, top to bottom of the cart. In some embodiments, the trays 826 can be selectively offloaded by actuating a conveyor of the arm 816 in the cell 842 where the desired tray 826 is located. The tray lift 818A, 818B having the desired tray 826 thereon can then be activated to move the desired tray 826 to the conveyor section 820.

In some embodiments, the number of tray positions of the tray lifts 818A, 818B may depend on the number of arms extend from each platform of the docking station 810 and/or the number of cells in a row of a transport vehicle 832. The body of the tray lifts 818A, 818B may further include one or more holding positions. A holding position is an additional tray position along the tray lift 818A, 818B.

The trays 826A offloaded from the transport vehicle 832 may be transferred to the platforms 814A or onto the tray lifts 818A, 818B. The trays 826A may be offloaded in any order. In some embodiments, the order in which the trays 826A are offloaded may be based on the order in which the trays 826A were loaded onto the transport vehicle 832 or based on the contents of the items contained in the trays 826A. A computer system may be aware of the organization and contents of the trays 826A by scanning machine-readable codes or RFID/NFC tags, as discussed above. The computer system may control the docking station 810 accordingly. For example, the trays 826A in the top row of the array of cells of the transport vehicle 832 may first be offloaded from the transport vehicle 832 by the arms of the platform 814A located on the top row of the docking station 810. The first row of cells may be first selected because they were loaded onto the transport vehicle 832 first, or because of the contents of the trays 826A.

In some embodiments, the trays 826A, 826B are organized in a proper conveying order in the transport vehicle 832. The arms may offload the trays 826A simultaneously by activating the conveyors 817 of the arms 816 simultaneously. When the trays 826A are offloaded onto the tray lift 818A, 818B simultaneously, the trays 826A are positioned into tray positions of the tray lift 818A, 818B in a conveying order. In some embodiments, the trays 826A, 826B are not organized in a proper conveying order in the transport vehicle 832. The arms 816 may be activated one at a time. Offloading the trays 826A in staggered intervals may advantageously allow the trays 826A to be shuffled into a proper conveying order. The method of shuffling the trays is described in greater detail in below. After the trays 826A are fully offloaded from the transport vehicle 832 to the tray lift 818A, 818B, the trays 826A are arranged in the proper conveying order with a first tray 826A in the first tray position 1, a second tray 826A in the second tray position 2, a third tray 826A in the third tray position 3, a fourth tray 826A in the fourth tray position 4, and a fifth tray 826A in a fifth tray position 5. The first tray may include contents to be transferred first.

To avoid stacking where a shuffled tray 826A blocks the remaining trays on the transport vehicle 832 from being offloaded, the tray lift 818A, 818B may, in some embodiments, be longer than the transport vehicle 832 and provide additional holding positions. For example, the tray lift 818A, 818B may include at least N+1 tray positions wherein “N” corresponds to the number of trays 826A in the conveying order. The tray positions in addition to the N number of tray positions may be holding positions. In such embodiments, the additional holding positions may be provided on either or both ends of the tray lift 818A, 818B. For example, the additional holding position may be a “zeroth” tray position and/or an “Nth+1” tray position. Alternatively, the tray lift 818A, 818B may comprise two holding positions located on the same end defining an “Nth+1” and an “Nth+2” tray position.

FIG. 8D depicts the trays 826A being lifted to a conveying position and the trays 826B being systemically offloaded from the transport vehicle 832 by the arms of the docking station 810. The trays 826C remain on the transport vehicle 832. The trays 826A correspond to the first batch of trays to be offloaded from the transport vehicle 832. In some embodiments, the trays 826A may correspond to the trays from the top/first row of the transport vehicle 832. The trays 826B, shown in FIG. 8D, correspond to a second batch of trays to be offloaded from the transport vehicle 832. In some embodiments, the trays 826B may correspond to the trays from the second row of the transport vehicle 832. The trays 826C, shown in FIG. 8D, correspond to trays remaining on the transport vehicle 832.

The tray lift 818A moves the trays 826A from a loading position to a conveying position. The arms of the docking station 810 offload the trays 826B onto the second tray lift 818B. In some embodiments, the trays 826B may be stored in the proper conveying order on the transport vehicle 832. In some embodiments, the trays 826B may be stored in an improper conveying order on the transport vehicle 832. The trays 826B may be offloaded simultaneously or one at a time as discussed above. The trays 826A may be offloaded onto the tray lift 818B before, during, or after the tray lift 818A elevates to a conveying position. After the trays 826B are fully offloaded from the transport vehicle 832 to the tray lift 818B, the trays 826B are arranged in the proper conveying order with a first tray 826B in the first tray position 1, a second tray 826B in the second tray position 2, a third tray 826B in the third tray position 3, a fourth tray 826B in the fourth tray position 4, and a fifth tray 826B in a fifth tray position 5. The first tray may include contents to be transferred first. In some embodiments, the proper conveying position of the first tray follow the last tray of trays 826A.

FIG. 8E depicts the tray lift 818A offloading the trays 826A to the cross conveyor 820. The trays 826B may be offloaded onto the tray lift 818B before, during, or after the trays 826A are conveyed to the cross conveyor 820. The trays 826A are located in the conveying position. The trays 826A correspond to the first batch of trays to be offloaded from the transport vehicle 832. In some embodiments, the trays 826A may correspond to the trays from the top/first row of the transport vehicle 832. The trays 826B, shown in FIG. 8E, correspond to a second batch of trays to be offloaded from the transport vehicle 832. In some embodiments, the trays 826B may correspond to the trays from the second row of the transport vehicle 832. The trays 826C, shown in FIG. 8E, correspond to trays remaining on the transport vehicle 832.

The conveyor of the tray lift 818A and the cross conveyor 820 are systematically activated to transport the trays 826A along the intake flow path. In some embodiments, the conveyors of the tray lift 818A and the cross conveyor 820 may be activated continuously. In some embodiments, the conveyors of the tray lift 818A and the cross conveyor 820 may be activated in alternating intervals. In such embodiments, only the tray lift 818A or the cross conveyor 820 are activated at a time. As discussed above, the orientation of the cross conveyor 820 with respect to the tray lift 818A, 818B may affect how trays 826A, 826B move or rotate when transferred from the tray lift 818A, 818B to the cross conveyor 820. Accordingly, in such embodiments, an alternating pattern of activating the conveyors of the tray lift 818A, 818B and cross conveyor 820 may be implemented. Additionally and/or alternatively, the cross conveyor 820 may include a driven section and a free rotating section. The driven section may include driven rollers. The free section may include freely rotating rollers. The driven section may be positioned adjacent to the tray lift 818A, 818B. The driven section and the tray lift 818A, 818B may be actuated in alternating intervals.

In some embodiments, the tray lift 818A and the cross conveyor 820 are activated in an alternating pattern. In such embodiments, the tray lift 818A is activated until a tray 826A is fully transferred to the cross conveyor 820. The cross conveyor 820 may be activated until the tray 826A is moved along the cross conveyor 820 to provide sufficient space for another tray 826A. In some embodiments, the cross conveyor 820 may be activated until the tray 826A is transferred from the driven section to the free section. Activating the conveyor in steps advantageously allows the first tray lift 818A to fully offload a tray 826A to the cross conveyor 820 before the cross conveyor 820 conveys the tray 826A away from the tray lift 818A. Otherwise, the trays 826A experience undesirable movement by rotating as one end of the tray 826A makes contact with the cross conveyor 820 while the other end of the tray 826A remains on the first tray lift 818A.

Additionally and/or alternatively, protective barriers may be implemented to encase the cross conveyor 820 and prevent trays 826A from rotating beyond the physical limitations established by the protective barriers. The protective barriers may be formed from any material strong enough to survive repeated contact with trays 826A while aligning the trays 826A during the transition from the first tray lift 818A to the cross conveyor 820. For example, the protective barriers may be formed from plexiglass.

FIG. 8F depicts the cross conveyor 820 conveying the trays 826A and the tray lift 818B moving the trays 826B from a loading position to a conveying position. The empty tray lift 818A is shown elevated above the conveying position to provide space for the tray lift 818B. The trays 826A correspond to the first batch of trays to be offloaded from the transport vehicle 832. In some embodiments, the trays 826A may correspond to the trays from the top/first row of the transport vehicle 832. The trays 826B, shown in FIG. 8F, correspond to a second batch of trays to be offloaded from the transport vehicle 832. In some embodiments, the trays 826B may correspond to the trays from the second row of the transport vehicle 832. The trays 826C, shown in FIG. 8F, correspond to trays remaining on the transport vehicle 832. The trays 826B may be offloaded similar to the trays 826A described above.

FIG. 8G depicts the tray lift 818B offloading the trays 826B to the cross conveyor 820, and the cross conveyor 820 conveying the trays 826A, 826B along the intake flow path to the transition mechanism 822. The trays 804C may be similarly offloaded onto the cross conveyor 818 as discussed above. The trays 826A correspond to the first batch of trays to be offloaded from the transport vehicle 832. In some embodiments, the trays 826A may correspond to the trays from the top/first row of the transport vehicle 832. The trays 826B, shown in FIG. 8G, correspond to a second batch of trays to be offloaded from the transport vehicle 832. In some embodiments, the trays 826B may correspond to the trays from the second row of the transport vehicle 832. The trays 826C, shown in FIG. 8G, correspond to trays remaining on the transport vehicle 832.

The transition mechanism 822 may move continuously or in steps. In some embodiments, the transition mechanism 822 runs continuously. In such embodiments, the basket 824A moves between the cross conveyor 820 and the tray content transfer system 804 while the basket 824B moves between the tray content transfer system 804 and the empty source tray collection 208. In some embodiments, the transition mechanism 822 is in sync with the tray lift 818A, 818B such that the transition mechanism 822 is activated when the tray lift 818A, 818B activates. Accordingly, the transition mechanism 822 is activated until a basket 824A is lifted to a conveying position ready to receive a tray 826A, 826B from the end of the cross conveyor 820. The cross conveyor 820 may be activated until a tray 826A, 826B is moved to an end position and transferred into the basket 824A. The transition mechanism 822 is again activated until the basket 824A is lowered to the tray content transfer system 804 and subsequently raised again to the conveying position.

FIG. 8H depicts the cross conveyor 820 transferring the trays 826A, 826B along the intake path along to the transition mechanism 822 and the transition mechanism transferring the trays 826A to the tray content transfer system 804. The tray content transfer system 804 transfers the items or contents contained in the trays 826A to the processing apparatus 806. The basket 824B of the transition mechanism transfers the empty trays 826A into the empty source tray collection 808. The trays 826A correspond to the first batch of trays to be offloaded from the transport vehicle 832. In some embodiments, the trays 826A may correspond to the trays from the top/first row of the transport vehicle 832. The trays 826B, shown in FIG. 8H, correspond to a second batch of trays to be offloaded from the transport vehicle 832. In some embodiments, the trays 826B may correspond to the trays from the second row of the transport vehicle 832. The trays 826C, shown in FIG. 8H, correspond to trays remaining on the transport vehicle 832.

In some embodiments, the tray content transfer system 804 may be configured to secure a tray 826A, 826B containing one or more items at a first location within a tray content transfer system 804; secure a second tray within the tray content transfer system 804 at a second location spaced along a longitudinal axis from the first location; secure one or more items contained within the tray 826A, 826B relative to the tray 826A, 826B; rotate the tray 826A, 826B and the second tray simultaneously about a rotation axis parallel to the longitudinal axis from an upright orientation to a rotated orientation; while the first tray 826A, 826B and the second tray are in the rotated orientation, moving the one or more items out of the first tray 826A, 826B, moving the one or more items parallel to the longitudinal axis to a position adjacent to the second tray, and moving the one or more items into the second tray; rotating the first tray 826A, 826B and the second tray simultaneously about the rotation axis from the rotated orientation to the upright orientation; releasing the one or more items into the second tray; and releasing the first tray 826A, 826B and the second tray. The tray content transfer system 804 transfers the second tray along with its contents to the processing apparatus 806. The tray content transfer system 804 transfers the first tray 826A, 826B to the basket 824B to be transferred to the empty source tray collection 808.

FIG. 8I depicts the source tray intake system preparing to repeat the process with the tray lifts 818A, 818B descending along the vertical supports 812B to a loading position adjacent to platforms 814 corresponding to subsequent rows of cells of the transport vehicle 836 while the trays 826A, 826B continue to travel along the intake flow path to the tray content transfer system 804. The subsequent rows of cells may be the first rows containing trays 826C below the empty cells. The trays 826A correspond to the first batch of trays to be offloaded from the transport vehicle 832. In some embodiments, the trays 826A may correspond to the trays from the top/first row of the transport vehicle 832. The trays 826B, shown in FIG. 8I, correspond to a second batch of trays to be offloaded from the transport vehicle 832. In some embodiments, the trays 826B may correspond to the trays from the second row of the transport vehicle 832. The trays 826C, shown in FIG. 8I, correspond to trays remaining on the transport vehicle 832.

FIG. 8J depicts a repetition of FIGS. 8C-E. Trays 826C are offloaded to the tray lift 818A and lifted to a conveying position. This process for transferring trays 826A, 826B, 826C, 826D from a transport vehicle 800 to the tray content transfer system 804 via a source tray intake process may be repeated until all trays 826A, 826B, 826C, 826D are processed and transferred to the tray content transfer system 804. The trays 826A correspond to the first batch of trays to be offloaded from the transport vehicle 832. In some embodiments, the trays 826A may correspond to the trays from the top/first row of the transport vehicle 832. The trays 826B, shown in FIG. 8J, correspond to a second batch of trays to be offloaded from the transport vehicle 832. In some embodiments, the trays 826B may correspond to the trays from the second row of the transport vehicle 832. The trays 826C, shown in FIG. 8J, correspond to the third batch of trays to be offloaded from the transport vehicle 832. In some embodiments, the trays 826C may correspond to the trays from the third row of the transport vehicle 832. The trays 826D, shown in FIG. 8J, correspond to the fourth batch of trays to be offloaded from the transport vehicle 832. In some embodiments, the trays 826D may correspond to the trays from the fourth row of the transport vehicle 832. The trays 826E, shown in FIG. 8J, correspond to the trays remaining on the transport vehicle 832.

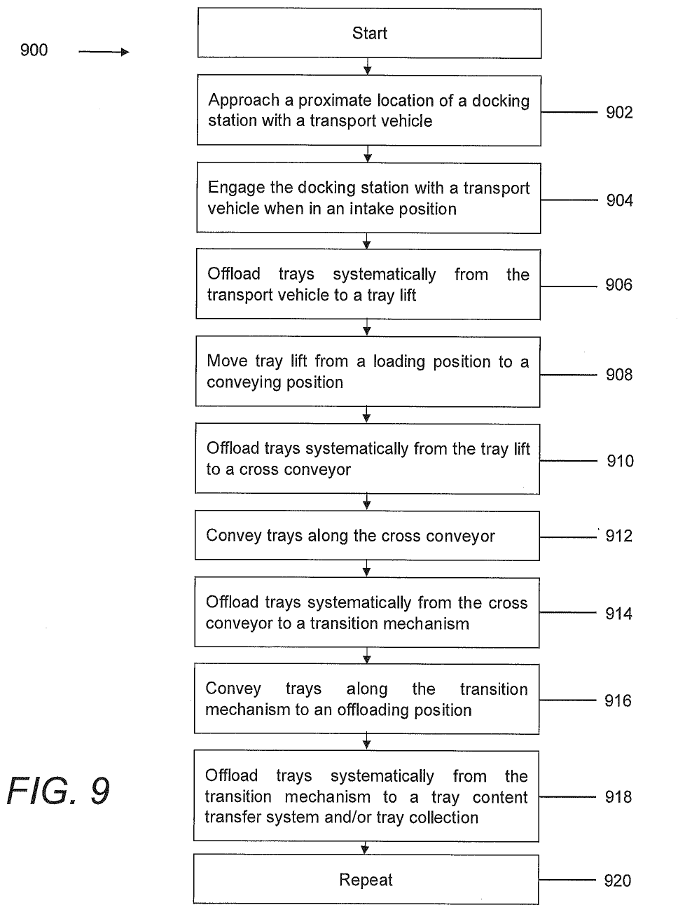

FIG. 9 is a flow chart illustrating an embodiment of a method 900 for conveying a source tray from a transport vehicle to a tray content transfer system and/or tray collection. The method 900 may implement the source tray intake system described above. For example, the method 900 may include steps shown in FIGS. 8A-J. The method 900 may be controlled and operate by one or more controls systems.

The method 900 begins with step 902 by approaching a proximate location of a docking station of a source tray intake system with a transport vehicle. The transport vehicle is loaded with a plurality of source trays. The plurality of source trays may be manually loaded onto the transport vehicle by human operators or automatically loaded onto the transport vehicle. In some embodiments, the stowed source trays are loaded in the transport vehicle according to a conveying order. In some embodiments, the stowed source trays are randomly stowed within a cell. The contents of each cell of the transport vehicle are determined by associating each source tray with its contents, and associating each cell with its stowed source tray. Step 902 may be illustrated in FIG. 8A.

The method then moves to step 904 by engaging the docking station with the transport vehicle when in an intake position. The transport vehicle moves to an intake position located adjacent to the docking station wherein each of the arms of the docking station align with a corresponding cell of the transport vehicle. The transport vehicle approaches the docking station such that each of the arms of the docking station extend through the corresponding cells of the transport vehicle. The arms of the docking station physically contact the stowed trays. Step 904 may be illustrated in FIG. 8B.

The method then moves to step 906 by offloading at least some of the trays systematically from the transport vehicle to a tray lift. In some embodiments, the trays are systematically offloaded row by row. In some embodiments, the rows are offloaded from top to bottom. In some embodiments, two rows are offloaded simultaneously onto two tray lifts. In some embodiments, two rows are offloaded one at a time. Step 906 may be illustrated in FIGS. 8C-D

In some embodiments the source trays are stowed in the transport vehicle already in a conveying order. In such embodiments, the source trays are offloaded according to step 906 in which at least some of the stowed trays are offloaded simultaneously.

In some embodiments, the source trays are not stowed in the transport vehicle already in a conveying order. In such embodiments, the source trays are offloaded according to step 906B in which at least some of the stowed trays are offloaded one at a time and shuffled into a conveying order. Step 906B shuffles the stowed source trays. The shuffling process may follow method 1000 described in greater detail below.

The method 900 then moves to step 908 by moving the tray lift from a loading position to a conveying position. The loading position may be at a first elevation and the conveying position may be at a second elevation. Accordingly, step 908 may move the loaded tray lift to a second elevation. The second elevation may be the elevation of a cross conveyor. In some embodiments, a second row may be offloaded under step 906 after a first row is moved to a conveying position under step 908. Step 908 may be illustrated in FIGS. 8D and 8F.

The method 900 then moves to step 910 by offloading trays systematically from the tray lift to a cross conveyor. In some embodiments, the conveyors of the tray lift and cross conveyor are continuously activated. In some embodiments, the conveyors of the tray lift and cross conveyor are activated in alternating increments. The trays are conveyed off of the tray lift onto the cross conveyor. Step 910 may be illustrated in FIGS. 8E and 8G.

The method 900 then moves to step 912 by conveying the trays along the cross conveyor. Step 912 moves the trays from a first end of the cross conveyor to a second end of the cross conveyor. The cross conveyor may be activated until the first tray reaches the second end of the cross conveyor. In some embodiments, the cross conveyor may be continuously activated. The trays may be prevented from being conveyed beyond the second end of the cross conveyor. In some embodiments, a stopper may be positioned at the second end of the cross conveyor to prevent trays from being conveyed beyond the second end of the cross conveyor. Step 912 may be illustrated in FIGS. 8E-F.

The method 900 then moves to step 914 by offloading the trays systematically from the cross conveyor to a transition mechanism. The trays may be offloaded one at a time. In some embodiments, the cross conveyor is selectively activated. The cross conveyor may be inactive until a basket of the transition mechanism is in a conveying position. Thus, the trays may wait at the second end of the cross conveyor until a basket is elevated into a conveying position. The cross conveyor may be activated when the basket is elevated into a conveying position to offload a single tray into the basket. The cross conveyor may be inactivated until another basket reaches the conveying position. In some embodiments, a stopper is selectively removed until a tray is offloaded onto the basket. This step may be repeated until all of the trays have been offloaded from the cross conveyor. Step 914 may be illustrated in FIG. 8G. In some embodiments, step 914 may be skipped such that the cross conveyor conveys the trays directly to a tray content transfer system.

The method 900 then moves to step 916 by conveying the trays along the transition mechanism to an offloading position. The offloading position may correspond to a tray content transfer system. In some embodiments, the transition mechanism moves a loaded basket from a conveying position to the offloading position. In some embodiments, the conveying position and offloading position may be the same such that the cross conveyor may convey directly to a tray content transfer system. Step 916 may be illustrated in FIG. 8H.

The method 900 then moves to step 918 by offloading trays systematically from the transition mechanism to a tray content transfer system and/or tray collection. The transition mechanism offloads the trays within the basket to a tray content transfer system. The tray content transfer system transfers the contents of the tray to another tray. The subsequent empty tray is loaded onto another basket and offloaded to an empty source tray collection. The empty source tray collection is a collection site for empty trays. The empty source trays may be used again to repeat the process. Step 918 may be illustrated in FIG. 8H.

The method 900 then moves to step 920 by repeating the process with subsequent rows of trays. In some embodiments, one or more steps may be repeated alone or in combination with other steps. The method 900 may be repeated until the transport vehicle is empty and all trays have been offloaded to the tray collection. The method 900 may be repeated with another transport vehicle.

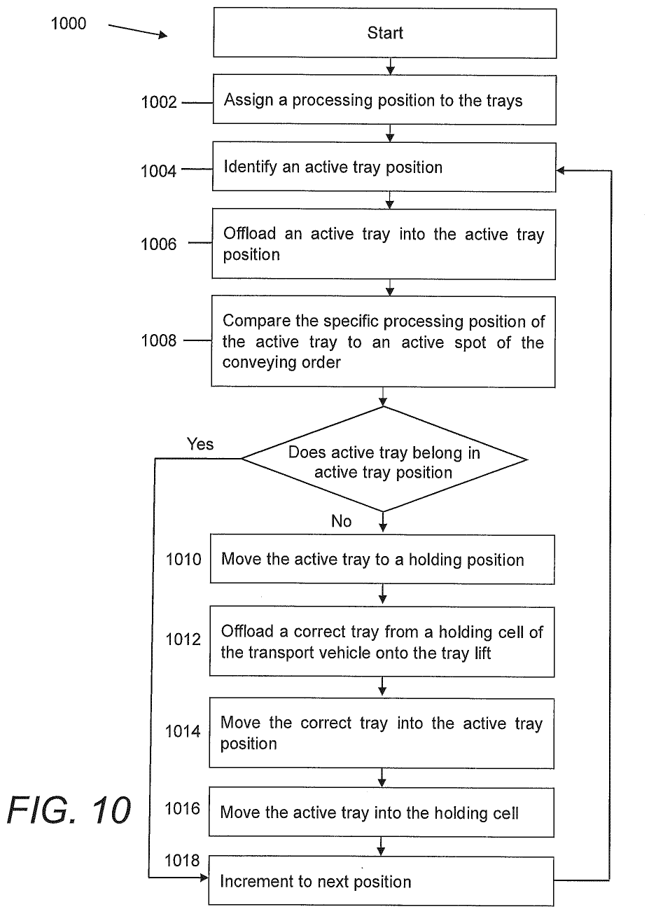

FIG. 10 is a flow chart illustrating an embodiment of a method 1000 for offloading a source tray from a transport vehicle to a tray lift. The method 1000 may implement the source tray intake system described above. The method 1000 may be used to shuffle trays into a correct conveying order. The method 1000 may be controlled and operate by one or more controls systems.

The method 1000 starts with step 1002 by assigning a processing position to the trays. The processing position is the position of the tray within the conveying order for the tray to be processed by the tray content transfer system. The conveying order may be an array or range of trays from a first tray to an Nth tray (e.g., [1, 2, . . . , N]). The processing position is the specific position of trays within the conveying order.

The method 1000 then moves to step 1004 by identifying an active tray position. The active tray position corresponds to the current tray position of the tray lift to be filled. The tray lift has an array or range of tray positions from a first tray position to an Nth tray position (e.g., [1, 2, . . . , N]). In some embodiments, the array or range or tray positions may include the same number of positions as the array or range of the conveying order. The current tray position corresponds to the active spot of the conveying order. The active spot of the conveying order is the one of the range of positions within the array or range of the conveying order to be placed in order. In some embodiments, the first active spot of the conveying order is the first tray to be processed.

The method 1000 then moves to step 1006 by offloading an active tray into the active tray position. The active tray is the stowed tray on the transport vehicle aligned with the identified active tray position. The arm of the docking station aligned with the active tray position is activated and conveys the active tray along the arm and onto the tray lift.

The method 1000 then moves to step 1008 by comparing the specific processing position of the active tray to the active spot of the conveying order. If the specific processing position of the active tray corresponds to the active spot of the conveying order then the method 1000 moves to step 1018.

If the specific processing position of the active tray does not correspond to the active spot of the conveying order then the method 1000 moves to step 1010 by moving the active tray to a holding position.

The method 1000 then moves to step 1012 by offloading a correct tray from the transport vehicle onto the tray lift. The correct tray contains contents corresponding to the current spot of the conveying order.

The method 1000 then moves to step 1014 by moving the correct tray into the active tray position. Accordingly, the tray containing the contents associated with the current spot of the conveying order is in active tray position.

The method 1000 then moves to step 1016 by moving the active tray into the cell previously holding the correct tray. Replacing the correct tray with the active tray clears the holding position of the active tray to prepare for the next iteration of shuffling.

The method 1000 then moves to step 1018 by repeating the incrementing the active spot of the conveying order, the active tray position, and the active tray and returning to step 1004.

Accordingly, the trays may be offloaded and moved according to a shuffling algorithm. In such embodiments, the conveyor of the tray lift may be a multi- or omni-directional conveyor such as a celluveyor to allow segments of the tray lift to be actuated or to actuate in different directions simultaneously.

The algorithm may prioritize shuffling trays into a conveying order. In some embodiments, the algorithm comprises the repeated shuffling steps of identifying an active tray position, wherein the active tray position is the current tray position corresponding to the active spot of the conveying order to be filled (e.g., first, second, third, fourth, fifth, or Nth tray); offload an active tray, wherein the active tray is the tray containing items belonging to the active tray position; comparing the contents of the active tray to the contents belonging to the active tray position; move the active tray to an active holding position; replacing the active tray with a correct tray; moving the correct tray to the active tray position. These steps may be repeated until all trays are offloaded and placed in the correct conveying order.

The initial active tray position may be identified as either the first or Nth tray position, while all subsequent active tray positions follow their preceding active tray position respectively. The initial active holding position is identified based on which end the algorithm decides to shuffle the trays. For example, if the first tray position is selected as the first active tray position, then the end of the tray lift located adjacent to the cross conveyor is selected. By comparison, if the Nth tray position is selected as the first active tray position, then the end of the tray lift located opposite the cross conveyor is selected. In such embodiments, the conveying order may be inverted.

The foregoing description details certain embodiments of the systems, devices, and methods disclosed herein. It will be appreciated, however, that no matter how detailed the foregoing appears in text, the systems, devices, and methods can be practiced in many ways. It should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

It is noted that some examples above may be described as a process, which is depicted as a flowchart, a flow diagram, a structure diagram, or a block diagram. Although a flowchart may describe the operations as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc. When a process corresponds to a software function, its termination corresponds to a return of the function to the calling function or the main function.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A tray transfer system comprising:
a source tray intake comprising:
a plurality of arms each of the plurality of arms having one or more conveyors wherein each of the one or more conveyors is configured to access a cell of a transport vehicle; and
one or more tray lifts wherein each one or more tray lifts comprises one or more conveyors, the one or more tray lifts proximate the plurality of arms and configured to receive a tray;
a cross conveyor comprising one or more conveyors and configured to receive the tray from the one or more tray lifts; and
a transition mechanism proximate the cross conveyor, the transition mechanism comprising:
one or more baskets configured to receive the tray; and
a lifting mechanism coupled to the one or more baskets wherein the lifting mechanism is configured to deliver the tray from the one or more baskets to a tray content transfer system and thereafter transport the trays to an empty source tray collection.

2. The tray transfer system of claim 1, wherein each arm of the plurality of arms comprises an actuator configured to independently actuate the one or more conveyors of the arm.

3. The tray transfer system of claim 1, wherein the one or more tray lifts is coupled to a lifting mechanism configured to elevate the one or more tray lifts from a first position proximate the plurality of arms to a second position proximate the cross conveyor.

4. The tray transfer system of claim 3, wherein the cross conveyor is elevated above a processing apparatus such that the cross conveyor is proximate to the one or more tray lifts when the one or more tray lifts is in the second position.

5. The tray transfer system of claim 1, wherein the one or more conveyors of each arm of the plurality of arms comprises a celluveyor.

6. The tray transfer system of claim 1, wherein the plurality of arms further comprises one or more scanners configured to read a computer readable code located on the tray; and selectively activate the one or more conveyors of the plurality of arms.

7. The tray transfer system of claim 1, wherein the one or more baskets comprises one or more conveyors configured to move the tray from the transition mechanism to the tray content transfer system.

8. The tray transfer system of claim 7, wherein the one or more conveyors of the one or more baskets comprises a celluveyor configured to move the tray in a multiple directions.

9. The tray transfer system of claim 1, wherein the plurality of arms extend from a plurality of platforms, wherein the docking station has a same number of platforms as the transport vehicle has rows and wherein each platform has the same number of arms as the transport vehicle has columns.

10. The tray transfer system of claim 1, wherein the transition mechanism is coupled to a lifting mechanism configured to lower the one or more baskets from a first position proximate the cross conveyor to a second position proximate the tray content transfer system.

11. The tray transfer system of claim 1, wherein the transport vehicle is an autonomous vehicle configured to automatically transport the tray from a storage location to the source tray intake upon receipt of a signal from the tray transfer system.

12. A method for operating a tray transfer system comprising:
positioning one of a plurality of arms in a plurality of cells of a transport vehicle;
moving a plurality of trays in the plurality of cells out of the transport vehicle and onto one or more tray lifts disposed proximate the plurality of arms, each of the tray lifts comprising one or more lift conveyors;
lifting, via the one or more tray lifts, the plurality of trays from a first elevation to a second elevation;
moving the trays via the one or more lift conveyors to a cross conveyor wherein the plurality of trays are moved individually onto the cross conveyor, the cross conveyor being disposed at the second elevation; and moving each of the plurality of trays via the cross conveyor into a basket a plurality of baskets of a transition mechanism;
lowering, via the plurality of baskets, each of the plurality of trays to an output position lower than the second position, the output position proximate an intake for a tray content transfer system; and
moving each of the plurality of trays to the tray content transfer system.

13. The method of claim 12, wherein each arm of the plurality of arms comprises an arm conveyor and each arm conveyor is independently operable from the arm conveyors on others of the plurality of arms.

14. The method of claim 12, wherein the cross conveyor is elevated above an item processing apparatus and wherein the tray content transfer system feeds items into the item processing apparatus.

15. The method of claim 12, further comprising:
scanning, via a scanner proximate the plurality of arms, one or more computer readable codes located on the plurality of trays; and
identifying, in one or more processors, based on the computer readable codes, a characteristic of items in a first tray of the plurality of trays;
selectively activate a conveyors of a first arm of the plurality of arms, the first arm being positioned within a first cell of the transfer vehicle, the first cell containing the first tray; and
moving the first tray of the plurality of trays into a first position on a first one of the one or more lift conveyors based on the identified characteristic.

16. The method of claim 15, further comprising identifying a second characteristic of a second tray of the plurality of trays; and
selectively activating a conveyor on the second arm, the second arm being inserted into a second cell of the plurality of cells of the transfer vehicle, the second cell containing the second tray.

17. The method of claim 16, further comprising:
moving the one or more tray lifts such that a second one of the one or more tray lifts is proximate the second arm; and moving the second tray onto the second one of the one or more tray lifts.

18. The tray transfer system of claim 15 wherein the characteristic of the items in one tray comprise an item type.

19. The tray transfer system of claim 15, wherein the characteristic comprises an intended delivery destination.

20. The method of claim 11, further comprising:
receiving, in an empty basket of the one or more baskets, an empty tray from the tray content transfer system; and
moving the empty tray out of the transition mechanism to a storage location.
